(19) United States
(12) Patent Application Publication
(10) Pub. No.: US 2013/0246281 A1
(43) Pub. Date: Sep. 19, 2013

(54) SERVICE PROVIDING SYSTEM AND UNIT DEVICE

(71) Applicants: KABUSHIKI KAISHA TOSHIBA, Minato-ku (JP); TOSHIBA SOLUTIONS CORPORATION, Minato-ku (JP)

(72) Inventors: Asahiko YAMADA, Tokorozawa-shi (JP); Koji Okada, Tokyo (JP); Tatsuro Ikeda, Fuchu-shi (JP)

(73) Assignees: TOSHIBA SOLUTIONS CORPORATION, Minato-ku (JP); KABUSHIKI KAISHA TOSHIBA, Minato-ku (JP)

(21) Appl. No.: 13/891,626

(22) Filed: May 10, 2013

Related U.S. Application Data
(63) Continuation of application No. PCT/JP11/75911, filed on Nov. 10, 2011.

(30) Foreign Application Priority Data
Nov. 10, 2010 (JP) 2010-252331

(51) Int. Cl. G06Q 20/40

(52) U.S. Cl. CPC G06Q 20/409
USPC 705/71

(57) ABSTRACT

According to one embodiment, the verifying device sends, to the service providing device, the user identification information in the user identification information certificate and the execution result that indicates properness when all the verification results are proper. the service providing device reads service user identification information associated with the user identification information in response to user identification information and a verification result. The service providing device sends the service information to the user terminal in accordance with the read service user identification information.

### CROSS REFERENCE TO RELATED APPLICATIONS

This application is a Continuation Application of PCT Application No. PCT/JP2011/075911, filed Nov. 10, 2011 and based upon and claiming the benefit of priority from Japanese Patent Application No. 2010-252331, filed Nov. 10, 2010, the entire contents of all of which are incorporated herein by reference.

### FIELD

Embodiments described herein relate generally to a service providing system and a unit device.

### BACKGROUND

In general, when a user receives a service from a service provider, a credit-card settlement based on a credit card of the user may be used. In the credit-card settlement of this kind, it is considered that a person having a credit card is identified by his/her signature. In deposit withdrawals or transfers in a bank, it is considered that a person having a bank card is identified by matching his/her personal identification number on the basis of the bank card number.

In this way, in the credit-card settlement and the deposit withdrawals or transfers, authentication by the signature or personal identification number is used in either real transactions in stores or in on-line virtual transactions.

However, in the credit-card settlement and the deposit withdrawals or transfers described above, it is impossible to identify the user of the credit card number or the bank card number and the personal identification number as the owner of the card. Therefore, the problem caused in the event of the leakage of service user identification information such as the credit card number or the bank card number and the personal identification number is that it is impossible to prevent the other person from pretending to be the owner of the card.

In real transactions in stores, it is necessary to carry and present a card such as the credit card or the bank card having service user identification information therein.

It is an object of the present invention to provide a service providing system and a unit device which eliminate the necessity of carrying and presenting a card having service user identification information therein and which can reduce the possibility of the leakage of the service user identification information and which enables the identification of a user.

### BRIEF DESCRIPTION OF THE DRAWINGS

FIG. 1 is a schematic diagram showing the configuration of a service providing system according to a first embodiment;

FIG. 2 is a schematic diagram illustrating a service process according to the embodiment;

FIG. 3 is a schematic diagram illustrating a storage unit 23 according to the embodiment;

FIG. 4 is a schematic diagram showing the configuration of a unit integrating device 30 according to the embodiment;

FIG. 5 is a schematic diagram illustrating a device information storage unit 33 according to the embodiment;

FIG. 6 is a schematic diagram showing the configurations of unit devices 40 and 50 according to the embodiment;

FIG. 7 is a schematic diagram illustrating an equipment certificate storage unit 44 according to the embodiment;

FIG. 8 is a schematic diagram illustrating an equipment certificate storage unit 54 according to the embodiment;

FIG. 9 is a schematic diagram illustrating user unique information 55a according to the embodiment;

FIG. 10 is a schematic diagram illustrating a first authentication context c1 according to the embodiment;

FIG. 11 is a schematic diagram illustrating a second authentication context c2 according to the embodiment;

FIG. 12 is a schematic diagram illustrating first authentication constituting process result information b1 according to the embodiment;

FIG. 13 is a schematic diagram illustrating second authentication constituting process result information b2 according to the embodiment;

FIG. 14 is a schematic diagram illustrating authentication processing result information b according to the embodiment;

FIG. 15 is a schematic diagram illustrating a storage unit 63 according to the embodiment;

FIG. 16 is a flowchart illustrating operations in steps ST1 to ST7 according to the embodiment;

FIG. 17 is a flowchart illustrating operations in steps ST8 to ST16 according to the embodiment;

FIG. 18 is a flowchart illustrating operations in steps ST17 to ST26 according to the embodiment;

FIG. 19 is a flowchart illustrating operations in steps ST27 to ST40 according to the embodiment;

FIG. 20 is a flowchart illustrating operations in steps ST41 to ST47 according to the embodiment;

FIG. 21 is a schematic diagram showing the configuration of a service providing system according to a second embodiment;

FIG. 22 is a schematic diagram illustrating a device information storage unit 33 according to the embodiment;

FIG. 23 is a schematic diagram illustrating a storage unit 23 according to the embodiment;

FIG. 24 is a schematic diagram illustrating a storage unit 63 according to the embodiment;

FIG. 25 is a schematic diagram illustrating authentication processing result information b according to the embodiment;

FIG. 26 is a flowchart illustrating operations according to the embodiment;

FIG. 27 is a schematic diagram illustrating a storage unit 63 according to a third embodiment;

FIG. 28 is a schematic diagram illustrating a storage unit 23 according to the embodiment; and

FIG. 29 is a flowchart illustrating operations in steps ST40 to ST47 according to the embodiment.

### DETAILED DESCRIPTION

In general, according to one embodiment, a service providing system comprises a plurality of unit devices, a unit integrating device, a user terminal, a verifying device, and a service providing device.

The unit devices independently execute authentication constituting processes constituting authentication processing that uses biometric authentication. The unit integrating device has each of the unit devices provided therein or externally connected thereto to communicate with each of the unit devices. The user terminal has the unit integrating device provided therein or externally connected thereto to communicate with the unit integrating device. The verifying device verifies the execution contents of each of the authentication constituting processes in accordance with an authenticator. The service providing device communicates with the user terminal and the verifying device.

Each of the unit devices comprises an equipment certificate storage module, an evaluation report storage module, a secret information storage module, an authentication constituting process executing module, an authenticator generating module, an authentication context generating module, an authentication constituting process result information generating module, and a result information sending module.

The equipment certificate storage module stores an equipment certificate issued to each of the unit devices by an equipment certificate issuer in accordance with a public key encryption method. The equipment certificate includes an equipment certificate body and a digital signature generated for the equipment certificate body by a secret key to the equipment certificate issuer. The equipment certificate body includes identification information for a public key of or for secret information to generate a message authentication code of the unit device to which the authentication constituting process belongs, unit device specifying information to specify the unit device to which the authentication constituting process belongs, and equipment certificate issuer information to specify the equipment certificate issuer.

The evaluation report storage module stores an evaluation report. The evaluation report includes the unit device specifying information, biometric authentication constituting process information to specify a biometric authentication constituting process including a biometric authentication algorithm used for the execution of the authentication constituting process, and biometric authentication accuracy indicating the accuracy of the biometric authentication by the biometric authentication algorithm.

The secret information storage module stores secret information to generate the authenticator.

The authentication constituting process executing module executes the authentication constituting process when each of the unit devices receives, from the unit integrating device, a random challenge value generated by the service providing device, and an authentication constituting process execution request to request the execution of the authentication constituting process.

The authenticator generating module generates the authenticator by the use of the secret information in accordance with the equipment certificate, the evaluation report, the challenge value, and the execution result.

The authentication context generating module generates an authentication context. The equipment certificate, the evaluation report, the challenge value, the execution result, and the authenticator are described in the authentication context in a specific format.

The authentication constituting process result information generating module generates authentication constituting process result information in which the authentication context and the execution result of the authentication constituting process are described in a specific format.

The result information sending module sends the authentication constituting process result information to the unit integrating device.

At least one of the unit devices further comprises user identification information certificate storage module.

The user identification information certificate storage module stores a user identification information certificate issued to a user of the user terminal by a third-party organization in accordance with a public key encryption method. The user identification information certificate includes a certificate body and a digital signature generated for the certificate body by a secret key to the third-party organization. The certificate body includes user identification information to identify the user, a hash value of biometric referential information for the user, and the third-party organization information to identify the third-party organization.

The authenticator generating module of at least one of the unit devices generates the authenticator by the use of the secret information in accordance with the equipment certificate, the evaluation report, the challenge value, the user identification information certificate, and the execution result.

The authentication context generating module of at least one of the unit devices generates an authentication context. The equipment certificate, the evaluation report, the challenge value, the user identification information certificate, the execution result, and the authenticator are described in the authentication context in a specific format.

The unit integrating device comprises a device information storage module, a first authentication constituting process execution request sending module, a second authentication constituting process execution request sending module, an authentication processing result information generating module, and an authentication processing result information sending module.

The device information storage module stores, in association with one another, unit device specifying information for each of the unit devices, a function name indicating a function in an authentication constituting process executed by each of the unit devices, and a processing order indicating the order of processing the functions.

The first authentication constituting process execution request sending module sends the challenge value and the authentication constituting process execution request to the unit device specified by the unit device specifying information in accordance with the processing order and the unit device specifying information in the device information storage module in response to an authentication processing execution request to request the execution of the authentication processing and the challenge value from the user terminal.

The second authentication constituting process execution request sending module sends the challenge value and the authentication constituting process execution request to the unit device subsequent to the sending destination unit device in the processing order in accordance with the processing order and the unit device specifying information in the device information storage module in response to the authentication constituting process result information from the unit device which is a sending destination of the authentication constituting process execution request.

The authentication processing result information generating module generates authentication processing result information in accordance with the processing order and the unit device specifying information in the unit device constituting information in response to the authentication constituting process result information from the unit device which is a sending destination of the authentication constituting process execution request when the sending destination unit device is the last unit device in the processing order. The authentication context in the authentication constituting process result information received from each of the unit devices and the execution result in the authentication constituting process result information received from the last unit device in the processing order are described in the authentication processing result information in a specific format.

The authentication processing result information sending module sends the authentication processing result information to the user terminal.

The user terminal comprises service request sending module, authentication processing execution request sending module, transfer module, and display.

The service request sending module sends, to the service providing device, a service request to request a service to the service providing device.

The authentication processing execution request sending module sends, to the unit integrating device, the challenge value and the authentication processing execution request in response to an authentication request which requests the user to perform the biometric authentication, and the challenge value from the service providing device.

The transfer module transfers, to the service providing device, authentication processing result information received from the unit integrating device.

The display module displays service information received from the service providing device.

The service providing device comprises a user information storage module, a service providing policy storage module, an authentication request sending module, a read module, and a service information sending module.

The user information storage module stores, in association with each other, user identification information in the user identification information certificate, and service user identification information which has a value different from that of the user identification information to identify the user.

The service providing policy storage module stores a service providing policy indicating conditions for providing services to the user. The service providing policy includes service identification information to identify the service, unit device specifying information used for the execution of the authentication constituting processes, the biometric authentication constituting process information to specify a biometric authentication constituting process including a biometric authentication algorithm, and a reference value indicating a reference for regarding the accuracy of the biometric authentication by the biometric authentication algorithm as proper.

The authentication request sending module generates and holds the challenge value and sends the challenge value and the authentication request to the user terminal in response to a service request from the user terminal.

The sending module sends the held challenge value, the authentication processing result information, and the service providing policy to the verifying device in response to authentication processing result information from the user terminal.

The read module searches the user information storage module in accordance with the user identification information and reads service user identification information associated with the user identification information in response to user identification information and a verification result from the verifying device when the verification result is proper.

The service information sending module sends the service information to the user terminal in accordance with the read service user identification information.

The verifying device comprises a public key storage module, a receiving module, a format verifying module, an authenticator verifying module, an equipment certificate verifying module, a user identification information certificate verifying module, an evaluation report verifying module, a challenge value verifying module, an execution result verifying module, and a user identification information sending module.

The public key storage module stores a public key to the equipment certificate issuer of each of the unit devices and a public key to the third-party organization.

The receiving module receives, from the service providing device, the challenge value, the authentication processing result information, and the service providing policy.

The format verifying module verifies that the received authentication processing result information fits the specific format.

The authenticator verifying module verifies an authenticator in the authentication context described in the received authentication processing result information.

The equipment certificate verifying module verifies the digital signature in the equipment certificate included in the authentication context described in the received authentication processing result information in accordance with the public key to the equipment certificate issuer.

The user identification information certificate verifying module verifies the digital signature in the user identification information certificate included in the authentication context described in the received authentication processing result information in accordance with the public key to the third-party organization.

The evaluation report verifying module verifies the evaluation report included in the authentication context described in the received authentication processing result information in accordance with the received service providing policy.

The challenge value verifying module verifies the challenge value in the authentication context described in the received authentication processing result information in accordance with the received challenge value.

The execution result verifying module verifies that the execution result described in the received authentication processing result information is proper.

The user identification information sending module sends, to the service providing device, the user identification information in the user identification information certificate used for the verification by the user identification information certificate verifying module and the execution result that indicates properness when all the verification results by the format verifying module, the authenticator verifying module, the equipment certificate verifying module, the user identification information certificate verifying module, the evaluation report verifying module, the challenge value verifying module, and the execution result verifying module are proper.

Hereinafter, embodiments will be described with reference to the drawings. Each of the following devices can be embodied by a hardware configuration, or a combinational configuration of a hardware resource and software. As the software of the combinational configuration, a program which is previously installed in a computer of a corresponding device from a network or a storage medium and which enables the functions of the corresponding device is used.

### First Embodiment

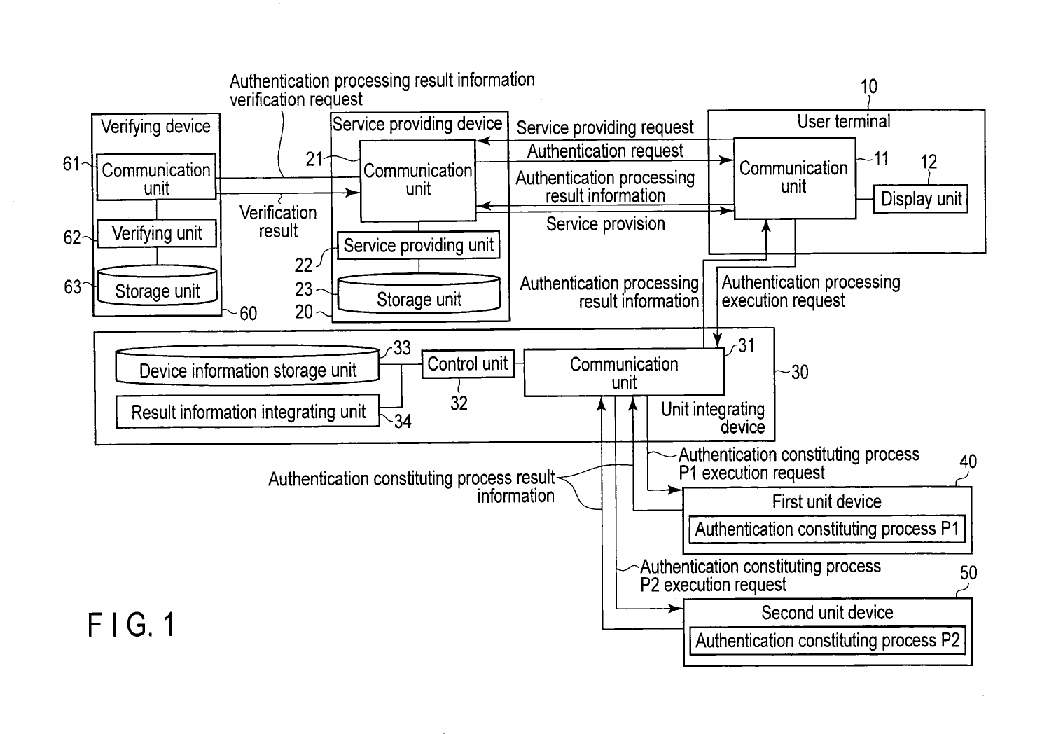

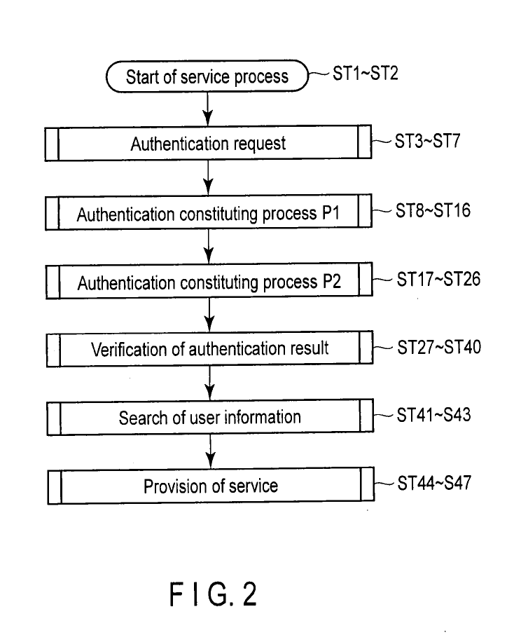

FIG. 1 is a schematic diagram showing the configuration of a service providing system according to a first embodiment. FIG. 2 is a schematic diagram illustrating a service process in the system. As shown in FIG. 2, the service process comprises an authentication request process, two authentication constituting processes P1 and P2, an authentication result verification process, a user information search process, and a service providing process. In the service process, an authentication result is verified in accordance with the execution results of the authentication constituting processes P1 and P2, user information is searched in accordance with the authentication verification result, and a service is provided in accordance with the user information. Each of the authentication constituting processes P1 and P2 is executed by one of different first and second unit devices 40 and 50. In the example shown here, the authentication constituting process P1 is executed by the first unit device 40, and the authentication constituting process P2 is executed by the second unit device 50.

Here, authentication processing refers to processing for checking whether a target (e.g., a person or a device) to be authenticated is proper. Being proper means that a standard by which a verifier approves of is satisfied. The authentication constituting process refers to a process that constitutes the authentication processing. For example, in authentication processing that uses biometric information, the authentication constituting process includes, 1) reading of biometric information, and 2) extraction of feature information. The 1) and 2) may be collectively referred to as one authentication constituting process.

The authentication processing comprises one or more authentication constituting processes, and these authentication constituting processes may be executed by different unit devices. A subsequent authentication constituting process may be executed with or without reference to a previous authentication constituting process.

The service providing system comprises a user terminal 10, a service providing device 20, a unit integrating device 30, the first unit device 40, the second unit device 50, and a verifying device 60. The unit devices 40 and 50 independently execute the authentication constituting processes P1 and P2 constituting the authentication processing that uses biometric information. For example, a fingerprint sensor or a CCD camera can be suitably used as the first unit device 40. For example, a SIM card, an IC card, or a micro SD card can be suitably used as the second unit device 50. For example, a mobile telephone can be used as the unit integrating device 30, and can have each of the unit devices 40 and 50 provided therein or externally connected thereto to communicate with each of the unit devices 40 and 50. For connection to an external storage medium, various cards serving as storage media and an interface such as a universal serial bus (USB) can be suitably used. The user terminal 10 can have the unit integrating device 30 provided therein or externally connected thereto to communicate with the unit integrating device 30. The verifying device 60 verifies the execution contents of each of the authentication constituting processes P1 and P2 in accordance with an authenticator. The service providing device 20 can communicate with the user terminal 10 and the verifying device 60.

Here, the user terminal 10 has a normal computer function, and comprises, for example, a communication unit 11 and a display unit 12.

The communication unit 11 has, for example, the following functions (f11-1) to (f11-3):

(f11-1) A service request sending function to send, to the service providing device 20, a service request to request a service to the service providing device 20.

(f11-2) An authentication processing execution request sending function to send a challenge value and processing execution request to the unit integrating device 30 in response to an authentication request which requests a user to perform a biometric authentication, and the random challenge value generated by the service providing device 20 from the service providing device 20.

(f11-3) A transfer function to transfer, to the service providing device 20, authentication processing result information received from the unit integrating device 30.

The display unit 12 has, for example, a display function to display service information received from the service providing device 20.

The service providing device 20 comprises a communication unit 21, a service providing unit 22, and a storage unit 23.

The communication unit 21 is a communication interface between the service providing unit 22 and each of the devices 10 and 60. The following explanations do not mention that a communication is performed through the communication unit 21.

The service providing unit 22 has, for example, the following functions (f22-1) to (f22-4):

(f22-1) An authentication request sending function to generate and hold a challenge value and send the challenge value and an authentication request to the user terminal 10 in response to a service request from the user terminal 10.

(f22-2) A sending function to send the held challenge value, the authentication processing result information, and a service providing policy to the verifying device 60 in response to the authentication processing result information from the user terminal 10.

(f22-3) A read function to search the storage unit 23 in accordance with the user identification information and read service user identification information associated with the user identification information in response to user identification information and a verification result from the verifying device 60 when the verification result is proper.

(f22-4) A service information sending function to send service information to the user terminal 10 in accordance with the read service user identification information.

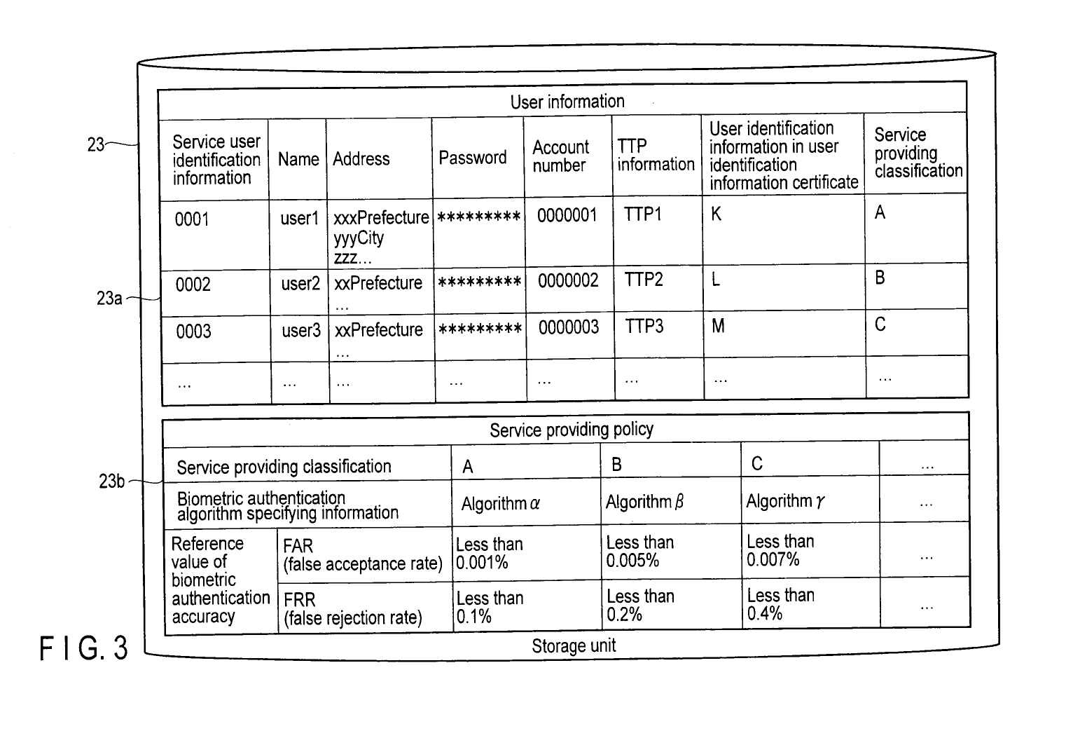

As shown in FIG. 3, user information 23a and a service providing policy 23b are stored in the storage unit 23.

The user identification information in a user identification information certificate, and the service user identification information which has a value different from that of the user identification information to identify a user are described in the user information 23a in association with each other. The service user identification information is, for example, a credit card number or a bank card number, and is identification information provided to the user by an operator (e.g., a credit sales company or a bank) of the service providing device 20. As the user information 23a, it is possible to suitably use a user name, an address, a password, an account number, trusted third party (TTP, also briefly referred to as a third-party organization) information, the user identification information in the user identification information certificate, a service providing classification that indicates the classification of service provision, and address information for the user terminal 10. The service information is, for example, information for users that can be provided by a credit sales company (e.g., usage state reference and a guide for discount service member stores), and is stored in an unshown storage unit (not shown).

The service providing policy 23b indicates conditions for providing services, and includes, for example, the service providing classification that indicates the classification of service provision, unit device specifying information (information to specify the first unit device 40 and the unit device 50) used for the execution of the authentication constituting processes, biometric authentication constituting process information to specify a biometric authentication constituting process including a biometric authentication algorithm, and a reference value indicating a reference for regarding the accuracy of the biometric authentication by the biometric authentication algorithm as proper. As the reference value, it is possible to suitably use, for example, a false acceptance rate (FAR) and/or a false rejection rate (FRR).

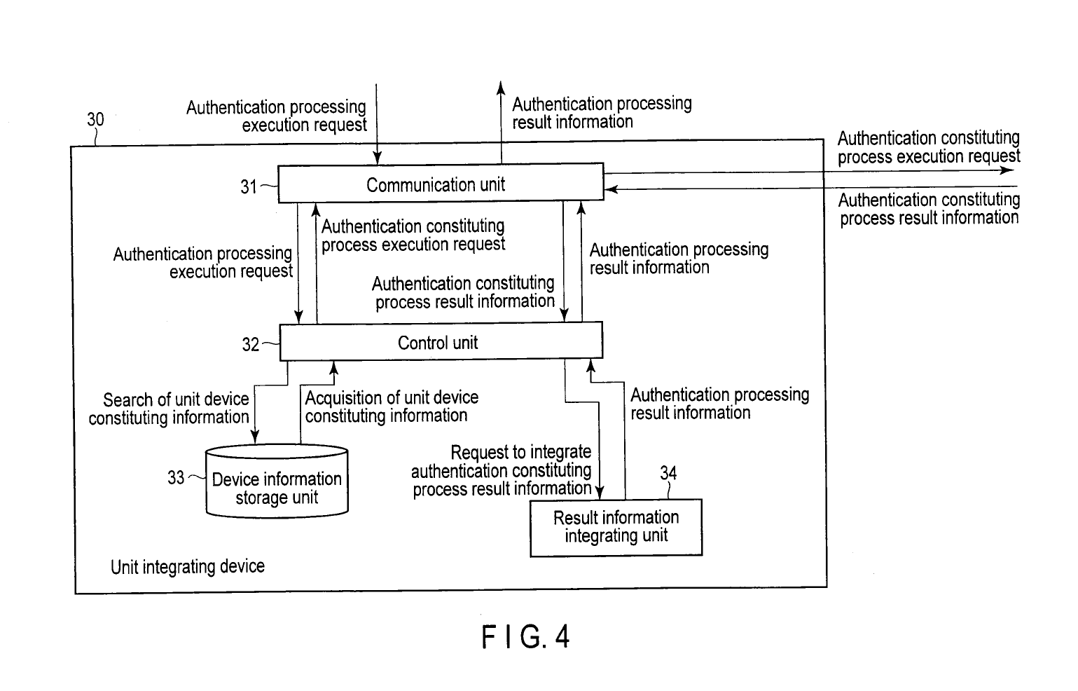

As shown in FIG. 4, the unit integrating device 30 comprises a communication unit 31, a control unit 32, a device information storage unit 33, and a result information integrating unit 34.

The communication unit 31 is a communication interface between the control unit 32 and each of the devices 10, 40, and 50. The following explanations do not mention that a communication is performed through the communication unit 31.

The control unit 32 has, for example, the following functions (f32-1) to (f32-4):

(f32-1) A first authentication constituting process execution request sending function to send the challenge value and the authentication constituting process execution request to the unit device 40 specified by the unit device specifying information in accordance with the processing order and the unit device specifying information in the device information storage unit 33 in response to an authentication processing execution request to request the execution of authentication processing and a challenge value from the user terminal 10.

(f32-2) A second authentication constituting process execution request sending function to send a challenge value and an authentication constituting process execution request to the unit device 50 subsequent to the sending destination unit device 40 in the processing order in accordance with the processing order and the unit device specifying information in the device information storage unit 33 in response to authentication constituting process result information from the first unit device 40 which is a sending destination of the authentication constituting process execution request.

(f32-3) An authentication processing result information generating function to generate authentication processing result information in accordance with the processing order and the unit device specifying information in unit device constituting information in response to the authentication constituting process result information from the unit device 50 which is a sending destination of the authentication constituting process execution request when the sending destination unit device 50 is the last unit device in the processing order. An authentication context in the authentication constituting process result information received from each of the unit devices 40 and 50 and the execution result in the authentication constituting process result information received from the last unit device in the processing order are described in the authentication processing result information in a specific format. This authentication processing result information generating function (f32-3) may be enabled, for example, by sending, to the result information integrating unit 34, the authentication constituting process result information received from each of the unit devices 40 and 50 and authentication constituting process result information integrating request and receiving authentication processing result information from the result information integrating unit 34.

(f32-4) An authentication processing result information sending function to send the authentication processing result information to the user terminal 10.

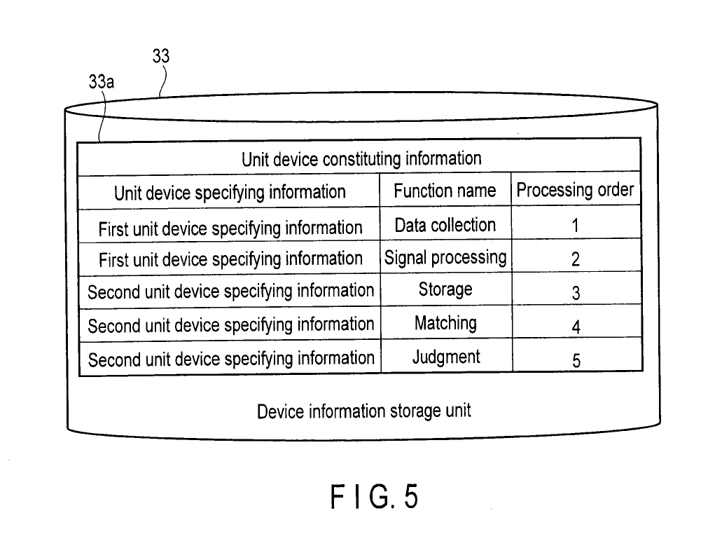

As shown in FIG. 5, a unit device constituting information 33a is stored in the device information storage unit 33. Unit device specifying information for each unit device, a function name indicating a function in an authentication constituting process executed by each unit device, and a processing order indicating the order of processing the functions are described in the unit device constituting information 33a in association with one another.

The result information integrating unit 34 integrates the authentication constituting process result information received from the control unit 32 and then sends the authentication processing result information to the control unit 32.

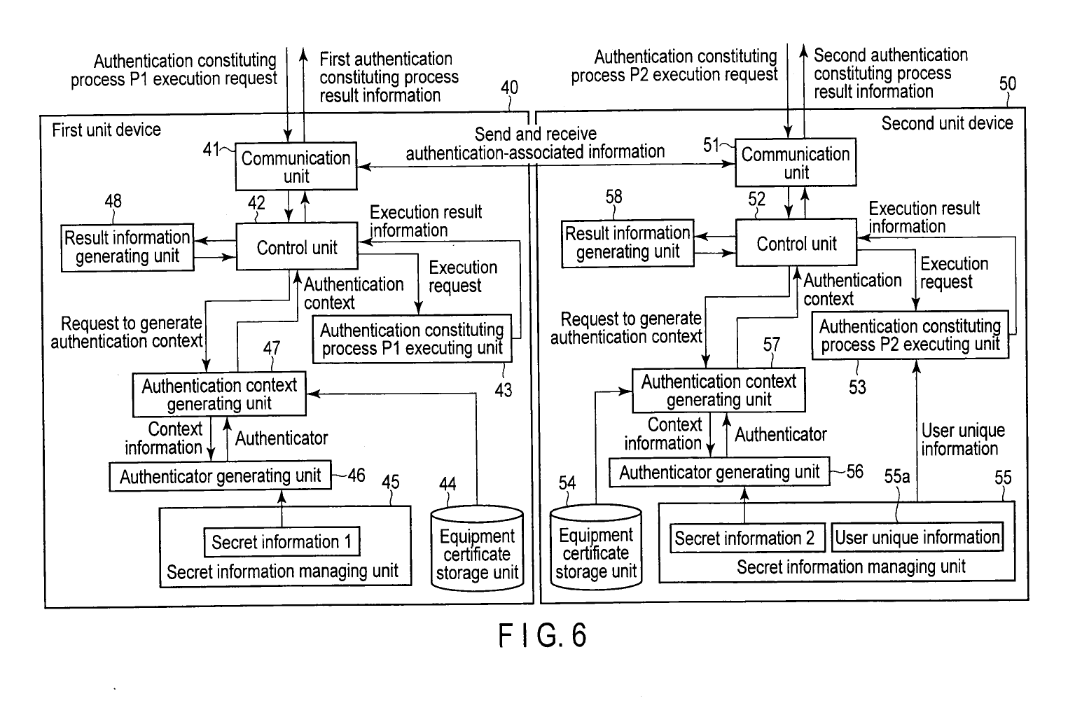

As shown in FIG. 6, the first and second unit devices 40 and 50 comprise communication units 41 and 51, control units 42 and 52, secret information managing units 45 and 55, authenticator generating units 46 and 56, equipment certificate storage units 44 and 54, authentication context generating units 47 and 57, and result information generating units 48 and 58. The first unit device 40 comprises an authentication constituting process P1 executing unit 43. The sending destination unit device 50 comprises an authentication constituting process P2 executing unit 53.

Here, the communication units 41 and 51 are communication interfaces between the control units 42 and 52a and the devices 30, 50, and 40. The following explanations do not mention that a communication is performed through the communication units 41 and 51.

The control units 42 and 52 have a function to control the units 41, 43 to 48 and 51, 53 to 58 to create authentication constituting process result information in accordance with the authentication constituting process execution request received from the unit integrating device 30 and send the authentication constituting process result information to the unit integrating device 30.

The control units 42 and 52 have, for example, the following functions (f42-1 and f52-1):

(f42-1 and f52-1) A function to send an execution request to the authentication constituting process P1 executing unit 43 and the authentication constituting process P2 executing unit 53 in response to a random challenge value generated by the service providing device 20 and an authentication constituting process execution request that requests the execution of the authentication constituting process from the unit integrating device 30.

(f42-2 and f52-2) A function to send, to the authentication context generating units 47 and 57, execution results and challenge values in the authentication constituting process P1 executing unit 43 and the execution result in the authentication constituting process P2 executing unit 53.

(f42-3 and f52-3) A function to send, to the result information generating units 48 and 58, authentication contexts sent from the authentication context generating units 47 and 57 and the execution results in the executing units 43 and 53.

(f42-4 and f52-4) A function to send, to the unit integrating device 30, the authentication constituting process result information sent from the result information generating units 48 and 58.

In response to an execution request from the control unit 42, the authentication constituting process P1 executing unit 43 executes an authentication constituting process P1, and sends the execution result to the control unit 42.

In response to an execution request from the control unit 52, the authentication constituting process P2 executing unit 53 reads user unique information 55a from the secret information managing unit 55, executes an authentication constituting process P2, and sends the execution result and the user identification information certificate in the user unique information 55a to the control unit 52.

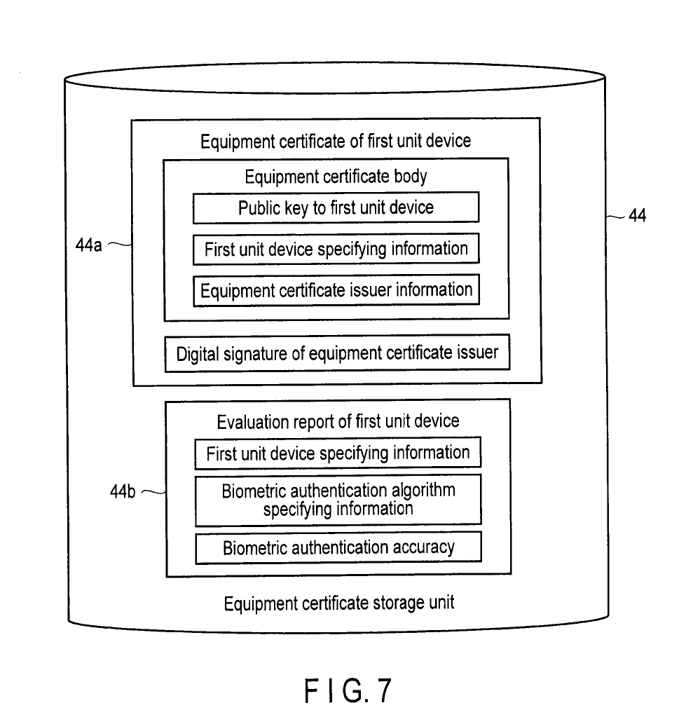

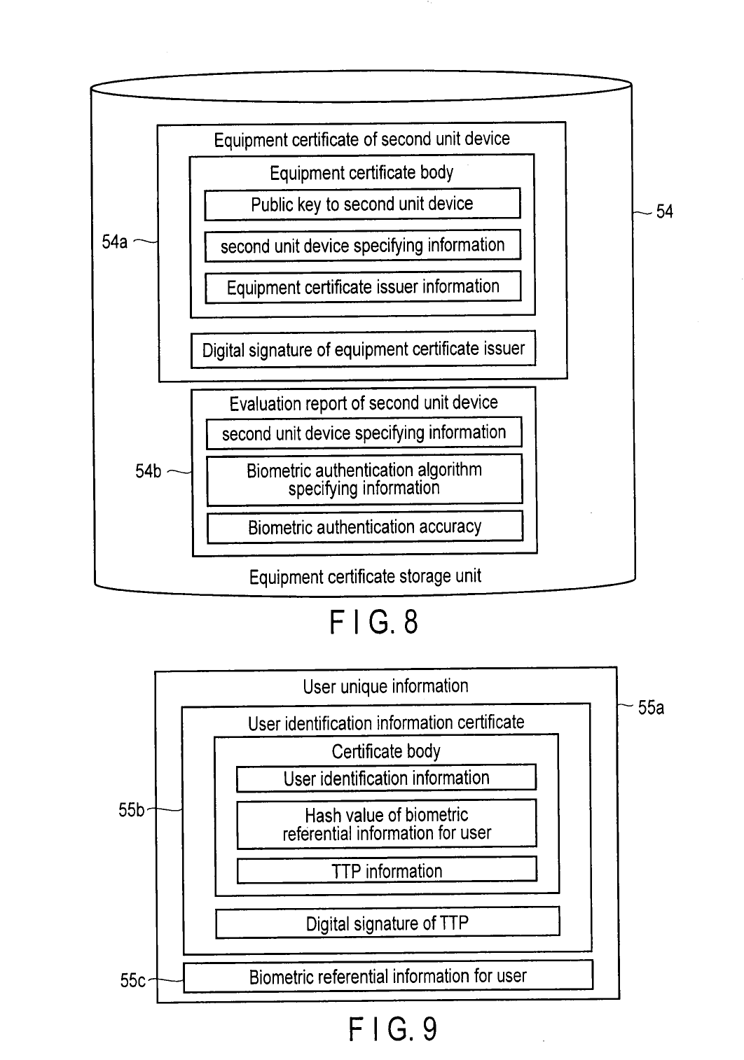

As shown in FIG. 7 and FIG. 8, equipment certificates (equipment public key certificates) 44a and 54a of the devices 40 and 50 and, and evaluation reports 44b and 54b of the devices are stored in the equipment certificate storage units 44 and 54. The equipment certificates 44a and 54a are issued to the unit devices 40 and 50 by an equipment certificate issuer in accordance with a public key encryption method. The equipment certificates 44a and 54a include an equipment certificate body and a digital signature generated for the equipment certificate body by a secret key to the equipment certificate issuer. The equipment certificate body including identification information for a public key of or for secret information to generate a message authentication code of the unit device to which the authentication constituting processes P1 and P2 belong, unit device specifying information to specify the unit devices 40 and 50 to which the authentication constituting processes P1 and P2 belong, and equipment certificate issuer information to specify the equipment certificate issuer. Here, the “information corresponding to the secret information” indicates information to specify a public key such as a public certificate. This also applies to the explanations in the following embodiments. The equipment certificate body may further comprise data on items including a field, a version, a serial number of the equipment certificate, a signature algorithm, an expiration date, and a biometric authentication device manufacturer.

The evaluation reports 44b and 54b include unit device specifying information (first unit device specifying information in FIG. 7 and second unit device specifying information in FIG. 8) for the authentication constituting processes P1 and P2, biometric authentication constituting process information to specify a biometric authentication constituting process including a biometric authentication algorithm used for execution, and biometric authentication accuracy indicating the accuracy of the biometric authentication by the biometric authentication algorithm. As the biometric authentication accuracy, it is possible to suitably use, for example, accuracy that fulfils a standardized matching accuracy evaluation reference (e.g., the aforementioned FRR or FAR) defined by a standardization association.

Evaluation items such as security may be attached to the evaluation reports 44b and 54b. An issuer of the evaluation reports 44b and 54b issues evaluation reports to the unit devices 40 and 50 authorized by, for example, a certificate authority (CA) based on a public key infrastructure. This certificate authority functions to evaluate and authorize biometric authentication accuracy that indicates the accuracy of the biometric authentication by the biometric authentication algorithm in the unit devices 40 and 50 in response to an application from a manufacturer of the unit devices 40 and 50. The certificate authority also functions to send the evaluation of the authorized contents to the requested manufacturer, and may add an electronic signature to the evaluation.

Secret information 1 for previously generating an authenticator is stored in the secret information managing unit 45. A secret key (not shown) corresponding to the public key to the first unit device 40 in the aforementioned equipment certificate 44a is also stored in the secret information managing unit 45.

Secret information 2 for previously generating an authenticator, and the user unique information 55a unique to the user are stored in the secret information managing unit 55. A secret key (not shown) corresponding to the public key to the second unit device 50 in the aforementioned equipment certificate 54a is also stored in the secret information managing unit 55.

It is also possible to use identification information for secret information for the generation of a message authentication code (MAC) instead of the public keys in the equipment certificates 44a and 54a (the public key to the first unit device in FIG. 7, and the public key to the second unit device in FIG. 8).

Here, the secret information 1 and the secret information 2 are provided to the first unit device and the second unit device, respectively. The secret information 1 or 2 is a pair of a secret key and a public key in the public key encryption method, for example, when the authenticator is a digital signature. The secret information 1 or 2 is a common key previously shared with the verifying device 60, for example, when the authenticator is a message authentication code. When the authenticator is a digital signature, public key certificates which correspond to the secret keys and which have been previously issued from the authority are stored in the secret information managing units 45 and 55. Although these public key certificates are assumed to be different from the aforementioned equipment certificates 44a and 54a, the aforementioned equipment certificates 44a and 54a may be used. When the equipment certificates 44a and 54a are used as the public key certificates, an authenticator is generated in accordance with the secret keys corresponding to the public keys to the unit devices 40 and 50.

As shown in FIG. 9, the user unique information 55a includes a user identification information certificate 55b. The user unique information 55a may further include user biometric referential information 55c.

The user identification information certificate 55b is issued to the user of the user terminal 10 by a third-party organization (TTP) in accordance with the public key encryption method. The user identification information certificate 55b includes a certificate body and a digital signature generated for the certificate body by a secret key to the TTP. The certificate body includes user identification information to identify the user, a hash value of biometric referential information for the user, and the TTP information to identify the TTP. The user identification information in the user identification information certificate 55b is provided by the TTP.

The authenticator generating units 46 and 56 generate an authenticator for input data by the use of secret information read from the secret information managing units 45 and 55. As the authenticator, it is possible to suitably use, for example, a digital signature or a message authentication code.

Here, the authenticator generating unit 46 functions to generate an authenticator by the use of the secret information 1 in the secret information managing unit 45 in accordance with the equipment certificate 44a, the evaluation report 44b, the challenge value, and the hash value of the execution result of the authentication constituting process P1 as execution contents that are received from the authentication context generating unit 47. The authenticator generating unit 46 also functions to send the generated authenticator to the authentication context generating unit 47.

The authenticator generating unit 56 functions to generate an authenticator by the use of the secret information 2 in the secret information managing unit 55 in accordance with the equipment certificate 54a, the evaluation report 54b, the challenge value, the user identification information certificate 55b, and the hash value of the execution result of the authentication constituting process P2 as execution contents that are received from the authentication context generating unit 57. The authenticator generating unit 56 also functions to send the generated authenticator to the authentication context generating unit 57.

The authentication context generating units 47 and 57 form, into a specific format, information regarding the execution of the authentication constituting process P1 executing unit 43 and the authentication constituting process P2 executing unit 53 and the authenticators output by the authenticator generating units 46 and 56, and output the results. In this text, formed information that is not easily put into the specific format by the authentication context generating units 47 and 57 is described as an authentication context.

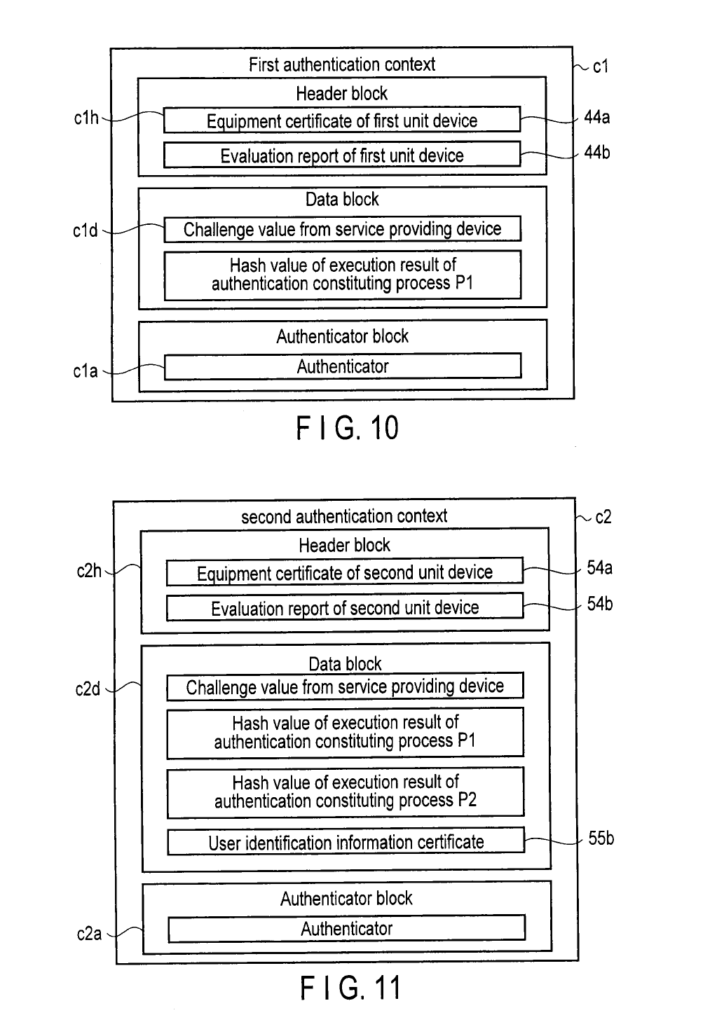

Here, as shown in FIG. 10, the authentication context generating unit 47 functions to generate a first authentication context c1. In the first authentication context c1, the equipment certificate 44a and the evaluation report 44b in the equipment certificate storage unit 44, the challenge value and the execution contents received from the control unit 42, and the authenticator received from the authenticator generating unit 46 are described in a specific format. The authentication context generating unit 47 also functions to send the generated first authentication context c1 to the control unit 42.

The first authentication context c1 comprises, for example, a header block c1h, a data block c1d, and an authenticator block c1a.

The equipment certificate 44a and the evaluation report 44b in the first unit device 40 are described in the header block c1h. The first unit device specifying information to specify the first unit device 40, and information regarding the structure of the first authentication context c1 may be further described in the header block c1h.

The challenge value from the service providing device 20, and the hash value of the execution result of the authentication constituting process P1 as execution contents are described in the data block c1d. Information included in an authentication constituting process P1 execution request may be further described in the data block c1d.

The authenticator received from the authenticator generating unit 46 is described in the authenticator block c1a.

As shown in FIG. 11, the authentication context generating unit 57 functions to generate a second authentication context c2. In the second authentication context c2, the equipment certificate 54a and the evaluation report 54b in the equipment certificate storage unit 54, the challenge value and the execution contents received from the control unit 52, and the authenticator received from the authenticator generating unit 56 are described in a specific format. The authentication context generating unit 57 also functions to send the generated second authentication context c2 to the control unit 52.

The second authentication context c2 comprises, for example, a header block c2h, a data block c2d, and an authenticator block c2a.

The equipment certificate 54a and the evaluation report 54b in the second unit device 50 are described in the header block c2h. The second unit device specifying information to specify the second unit device 50, and information regarding the structure of the second authentication context c2 may be further described in the header block c2h.

The challenge value from the service providing device 20, the hash value of the execution result of the authentication constituting process P2 as execution contents, and the user identification information certificate 55b of the user are described in the data block c2d. Data corresponding to the hash value of the execution result of the authentication constituting process P1 is further stored in the data block c2d. This means that the data corresponding to the hash values of the respective execution results are stored so that the execution result of the authentication constituting process P1 as an input and the execution result of the authentication constituting process P2 as an output are a pair of data. Information included in an authentication constituting process P2 execution request may be further described in the data block c2d.

The authenticator received from the authenticator generating unit 56 is described in the authenticator block c2a.

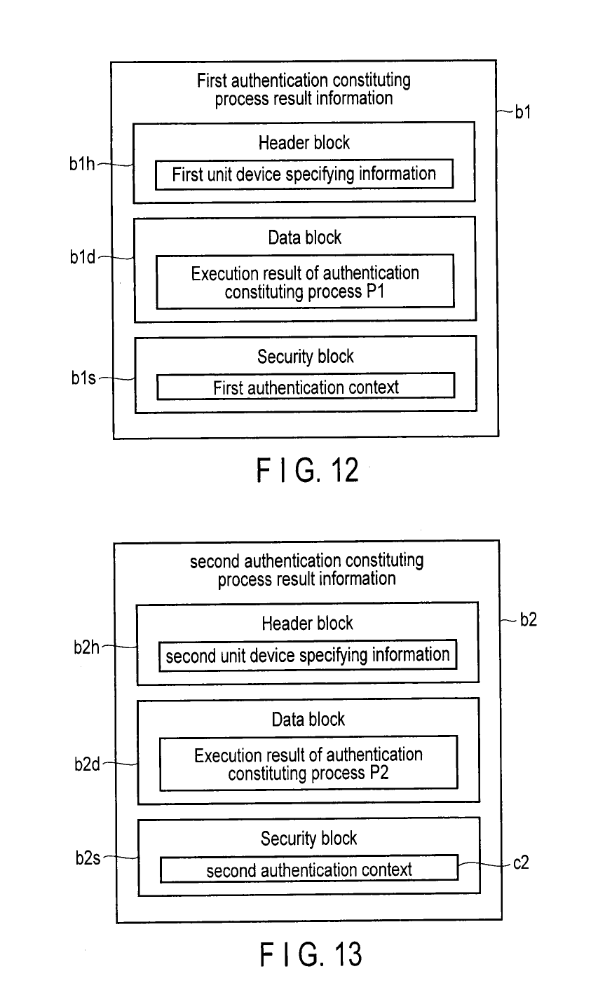

As shown in FIG. 12, the result information generating unit 48 functions to generate first authentication constituting process result information b1. In the first authentication constituting process result information b1, the first authentication context c1 received from the control unit 42, and the execution result of the authentication constituting process P1 are described in a specific format. The result information generating unit 48 also functions to send the generated first authentication constituting process result information b1 to the control unit 42.

The first authentication constituting process result information b1 comprises, for example, a header block b1h, a data block b1d, and a security block b1s.

First unit device specifying information similar to that in the equipment certificate 44a within the first authentication context c1 is described in the header block b1h. Information regarding the structure of the first authentication constituting process result information b1 may be further described in the header block b1h.

The execution result of the authentication constituting process P1 by the authentication constituting process P1 executing unit 43 is described in the data block bid.

The first authentication context c1 is described in the security block b1s. Information regarding the encryption of the data block b1d, authenticators provided to the header block b1h and the data block b1d, and information regarding the authenticators may be further described in the security block bis.

As shown in FIG. 13, the result information generating unit 58 functions to generate second authentication constituting process result information b2. In the second authentication constituting process result information b2, the second authentication context c2 received from the control unit 52, and the execution result of the authentication constituting process P2 are described in a specific format. The result information generating unit 58 also functions to send the generated second authentication constituting process result information b2 to the control unit 52.

The second authentication constituting process result information b2 comprises, for example, a header block b2h, a data block b2d, and a security block b2s.

Second unit device specifying information similar to that in the equipment certificate 54a within the second authentication context c2 is described in the header block b2h. Information regarding the structure of the second authentication constituting process result information b2 may be further described in the header block b2h.

The execution result of the authentication constituting process P2 by the authentication constituting process P2 executing unit 53 is described in the data block b2d.

The second authentication context c2 is described in the security block b2s. Information regarding the encryption of the data block b2d, authenticators provided to the header block b2h and the data block b2d, and information regarding the authenticators may be further described in the security block b2s. The security block b2s may further include the first authentication context c1 included in the security block b1s of the first authentication constituting process result information b1.

As described above, the first authentication constituting process result information b1 and the second authentication constituting process result information b2 are integrated into authentication processing result information b by the unit integrating device 30.

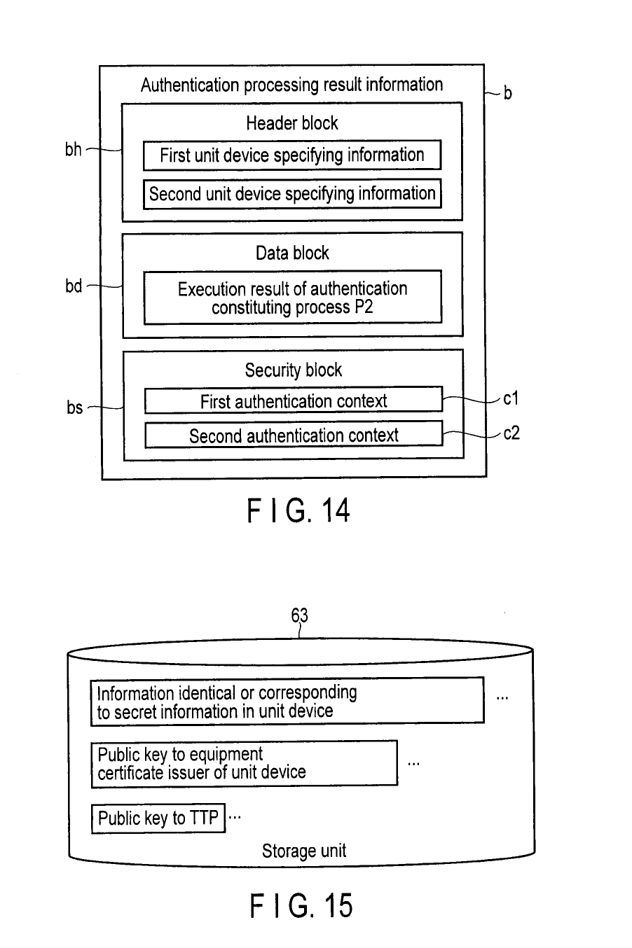

As shown in FIG. 14, the authentication processing result information b comprises, for example, a header block bh, a data block bd, and a security block bs. The header block bh and the data block bd may be omitted as required by a system.

First and second unit device specifying information extracted from the header blocks b1h and b2h in the first authentication constituting process result information b1 and the second authentication constituting process result information b2 are described in the header block bh. Information regarding the structure of the authentication processing result information b may be further described in the header block bh.

The execution result of the authentication constituting process P2 extracted from the data block b2d in the second authentication constituting process result information b2 is described in the data block bd.

The first and second authentication contexts c1 and c2 extracted from the security blocks b1s and b2s in the first authentication constituting process result information b1 and the second authentication constituting process result information b2 are described in the security block bs. Information regarding the encryption of the data block bd, authenticators provided to the header block bh and the data block bd, and information regarding the authenticators may be further described in the security block bs.

As shown in FIG. 1, the verifying device 60 comprises a communication unit 61, a verifying unit 62, and a storage unit 63.

The communication unit 61 is a communication interface between the verifying unit 62 and the service providing device 20. The following explanations do not mention that a communication is performed through the communication unit 61.

The verifying unit 62 has, for example, the following functions (f62-1) to (f62-9):

(f62-1) A receiving function to receive, from the service providing device 20, the challenge value, the authentication processing result information b, and the service providing policy 23b.

(f62-2) A format verifying function to verify that the received authentication processing result information b fits the specific format.

(f62-3) An authenticator verifying function to verify authenticators in the authentication contexts c1 and c2 described in the received authentication processing result information b.

(f62-4) An equipment certificate verifying function to verify the digital signatures in the equipment certificates 44a and 54a included in the authentication contexts c1 and c2 described in the received authentication processing result information b in accordance with the public key to the equipment certificate issuer in the storage unit 63.

(f62-5) A user identification information certificate verifying function to verify the digital signature in the user identification information certificate 55b included in the authentication contexts c1 and c2 described in the received authentication processing result information b in accordance with the public key to the third-party organization in the storage unit 63.

(f62-6) An evaluation report verifying function to verify the evaluation reports 44b and 54b included in the authentication contexts c1 and c2 described in the received authentication processing result information b in accordance with the received service providing policy 23b.

(f62-7) A challenge value verifying function to verify the challenge values in the authentication contexts c1 and c2 described in the received authentication processing result information b in accordance with the received challenge value.

(f62-8) An execution result verifying function to verify that the execution result described in the received authentication processing result information b is proper.

(f62-9) A user identification information sending function to send, to the service providing device 20, the user identification information in the user identification information certificate 55b used for the verification by the user identification information certificate verifying function and the verification result that indicates properness when all the verification results by the format verifying function, the authenticator verifying function, the equipment certificate verifying function, the user identification information certificate verifying function, the evaluation report verifying function, the challenge value verifying function, and the execution result verifying function are proper.

The storage unit 63 is a storage device readable/writable from the verifying unit 62. As shown in. FIG. 15, the public key to the equipment certificate issuer of each of the unit devices 40 and 50 and the public key to the TTP are stored in the storage unit 63. Information identical or corresponding to secret information 1 and secret information 2 for the unit devices 40 and 50 may be stored in the storage unit 63. The information in the storage unit 63 is omitted when the authenticator is generated by the secret key to each of the unit devices 40 and 50 (because the authenticator can be verified by the public key to each of the unit devices 40 and 50 in the equipment certificates 44a and 54a).

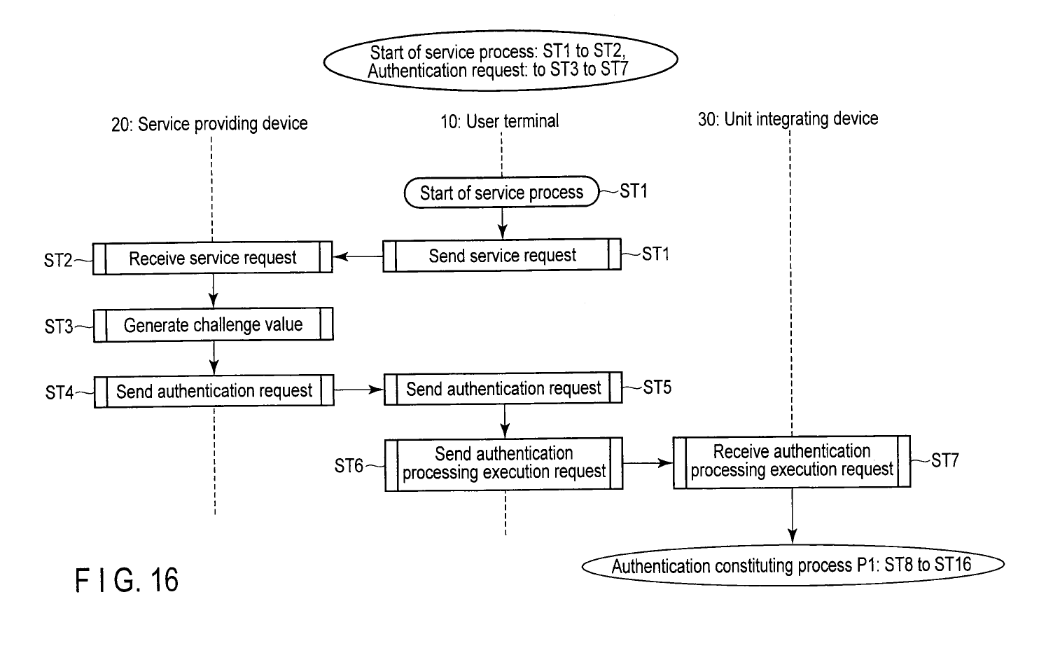

Now, the operation of the authentication system having the above configuration is described with reference to flowcharts in FIG. 2 and FIG. 16 to FIG. 20.

In the user terminal 10, the user selects a service in accordance with a screen displayed on the display unit 12. Accordingly, as shown in FIG. 10, a service request is sent to the service providing device 20 from the user terminal 10 (ST1), and a service process is thereby started. The service request may include, for example, the specification of an authentication method to be performed, and the specification of a method of communication between the user terminal 10 and the unit integrating device 30.

In the service providing device 20, when the service providing unit 22 receives the service request (ST2), the following authentication processing is performed in accordance with an authentication method that is predetermined or that is specified by the service request. The service providing unit 22 generates a challenge value comprising, for example, random numbers (ST3), and then holds the challenge value and sends this challenge value and an authentication request to the user terminal 10 (ST4). The authentication request may include, for example, information that specifies authentication processing, and information that specifies several matching algorithms.

In response to the challenge value and the authentication request (ST5), the user terminal 10 sends the challenge value and an authentication processing execution request to the unit integrating device 30 (ST6).

When the unit integrating device 30 receives the challenge value and the authentication processing execution request (ST7), the control unit 32 searches the unit device constituting information 33a of the device information storage unit 33 and thus judges the processing order of the first unit device 40 and the second unit device 50.

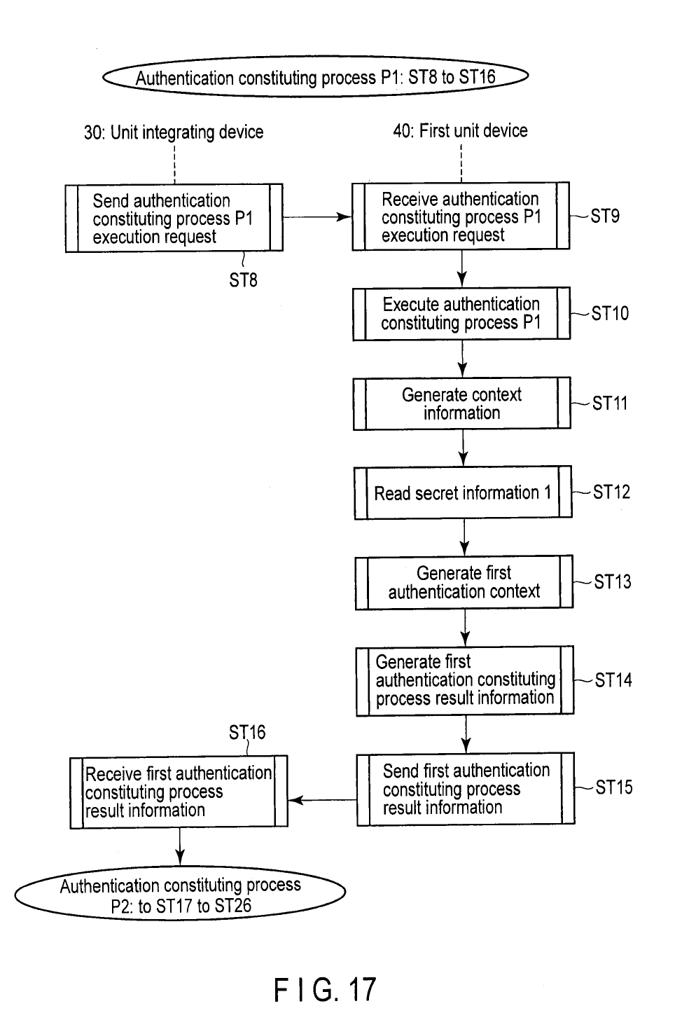

Subsequently, as shown in FIG. 17, the unit integrating device 30 sends a challenge value and an authentication constituting process P1 execution request to the first unit device 40 which comes first in the processing order (ST8).

When the first unit device 40 receives the challenge value and the authentication constituting process P1 execution request (ST9), the control unit 42 causes the authentication constituting process P1 executing unit 43 to execute the authentication constituting process P1 in accordance with authentication processing that is predetermined or that is specified by the authentication request from the service providing device 20, thereby obtaining an execution result (ST10). That is, as shown in FIG. 5 by way of example, the authentication constituting process P1 obtains, as an execution result, biometric information (e.g., fingerprint information) generated by a function of sequentially executing a data collection function for collecting biometric data for the user and a signal processing function for the signal processing of the collected biometric data.

The control unit 42 then sends, to the authentication context generating unit 47, the execution result of the authentication constituting process P1 and the challenge value from the service providing device 20.

The authentication context generating unit 47 describes the header block c1h and the data block c1d of the first authentication context c1 to generate context information comprising the blocks c1h and c1d (ST11), and sends the context information to the authenticator generating unit 46.

When receiving the context information, the authenticator generating unit 46 reads the secret information 1 for authenticator generation from the secret information managing unit 45 (ST12). The authenticator generating unit 46 then uses the secret information 1 to generate an authenticator in accordance with the context information, and sends the authenticator to the authentication context generating unit 47.

The authentication context generating unit 47 describes this authenticator in the authenticator block c1a, and generates a first authentication context c1 comprising three blocks c1h, c1d, and c1a (ST13).

When receiving the first authentication context c1 from the authentication context generating unit 47, the control unit 42 sends the first authentication context c1 and the execution result of the authentication constituting process P1 to the result information generating unit 48.

The result information generating unit 48 describes the first authentication context c1 and the execution result of the authentication constituting process P1 in a specific format to generate first authentication constituting process result information b1 (ST14), and sends the first authentication constituting process result information b1 to the control unit 42.

The control unit 42 uses the communication unit 41 to send the first authentication constituting process result information b1 to the unit integrating device 30 (ST15).

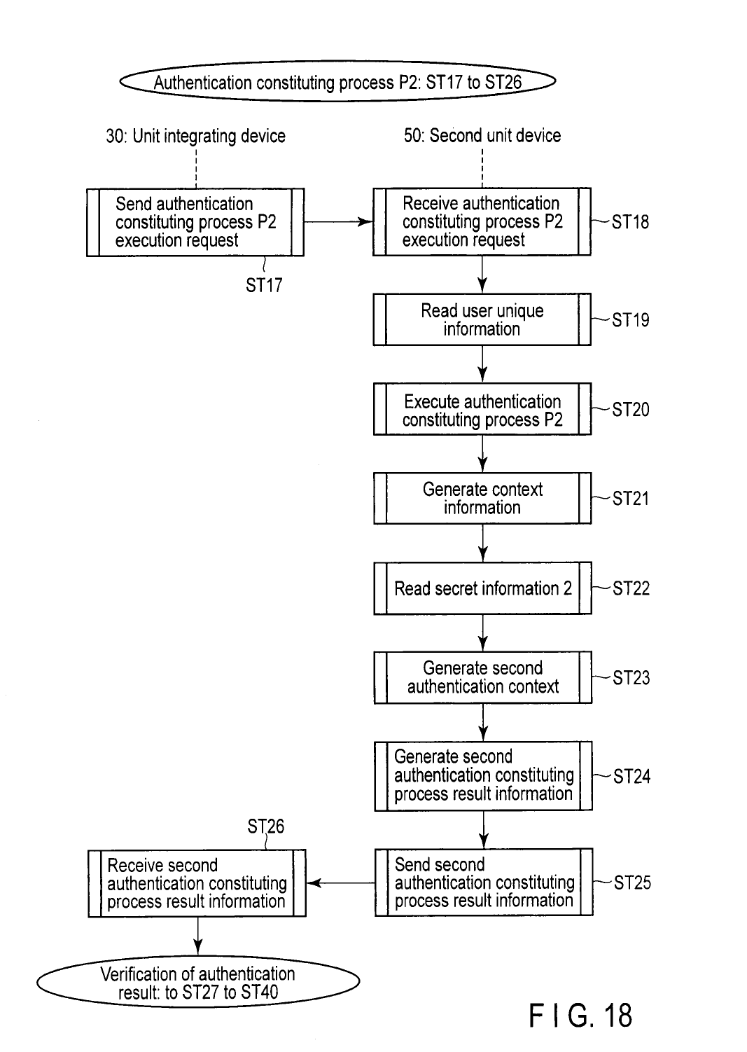

When the unit integrating device 30 receives the first authentication constituting process result information b1 (ST16), the control unit 32 then sends the first authentication constituting process result information b1 and an authentication constituting process P2 execution request to the second unit device 50 which comes next in the processing order in accordance with the execution result in the device information storage unit 33, as shown in FIG. 18 (ST17).

When the second unit device 50 receives the challenge value, the first authentication constituting process result information b1, and the authentication constituting process P2 execution request (ST18), the control unit 52 sends, to the authentication constituting process P2 executing unit 53, the execution result of the authentication constituting process P1 extracted from the first authentication constituting process result information b1, and an execution request, in accordance with the authentication processing that is predetermined or that is specified by the authentication request from the service providing device 20.

The authentication constituting process P2 executing unit 53 reads the user unique information 55a from the secret information managing unit 55 (ST19), and executes the authentication constituting process P2 in accordance with the user biometric referential information 55c out of the user unique information and the execution result of the authentication constituting process P1 (ST20), thereby obtaining an execution result. That is, as shown in FIG. 5 by way of example, the authentication constituting process P2 obtains, as an execution result, successful authentication (unsuccessful authentication) by the processing of sequentially executing a storage function for storing the biometric referential information for the user, a matching function for matching the user biometric information against the biometric referential information 55c, and a judging function for judging by the matching result whether the authentication is successful. The authentication constituting process P2 executing unit 53 may compare the hash value calculated from the user biometric referential information 55c with the hash value of the biometric referential information in the user identification information certificate 55b, and further perform processing to judge that the authentication is unsuccessful regardless of the result of the authentication constituting process P2 when the hash values do not correspond to each other.

The control unit 52 then sends, to the authentication context generating unit 57, the execution result of the authentication constituting process P2, the user identification information certificate 55b out of the user unique information, and the challenge value.

The authentication context generating unit 57 describes the header block c2h and the data block c2d of the second authentication context c2 to generate context information comprising the blocks c2h and c2d (ST21), and sends the context information to the authenticator generating unit 56.

When receiving the context information, the authenticator generating unit 56 reads the secret information 2 for authenticator generation from the secret information managing unit 55 (ST22). The authenticator generating unit 56 then uses the secret information 2 to generate an authenticator in accordance with the context information, and sends the authenticator to the authentication context generating unit 57.

The authentication context generating unit 57 describes this authenticator in the authenticator block c2a, and generates a second authentication context c2 comprising three blocks c2h, c2d, and c2a (ST23).

When receiving the second authentication context c2 from the authentication context generating unit 57, the control unit 52 sends the second authentication context c2 and the execution result of the authentication constituting process P2 to the result information generating unit 58.

The result information generating unit 58 describes the second authentication context c2 and the execution result of the authentication constituting process P2 in a specific format to generate second authentication constituting process result information b2 (ST24), and sends the second authentication constituting process result information b2 to the control unit 52.

The control unit 52 uses the communication unit 51 to send the second authentication constituting process result information b2 to the unit integrating device 30 (ST25).

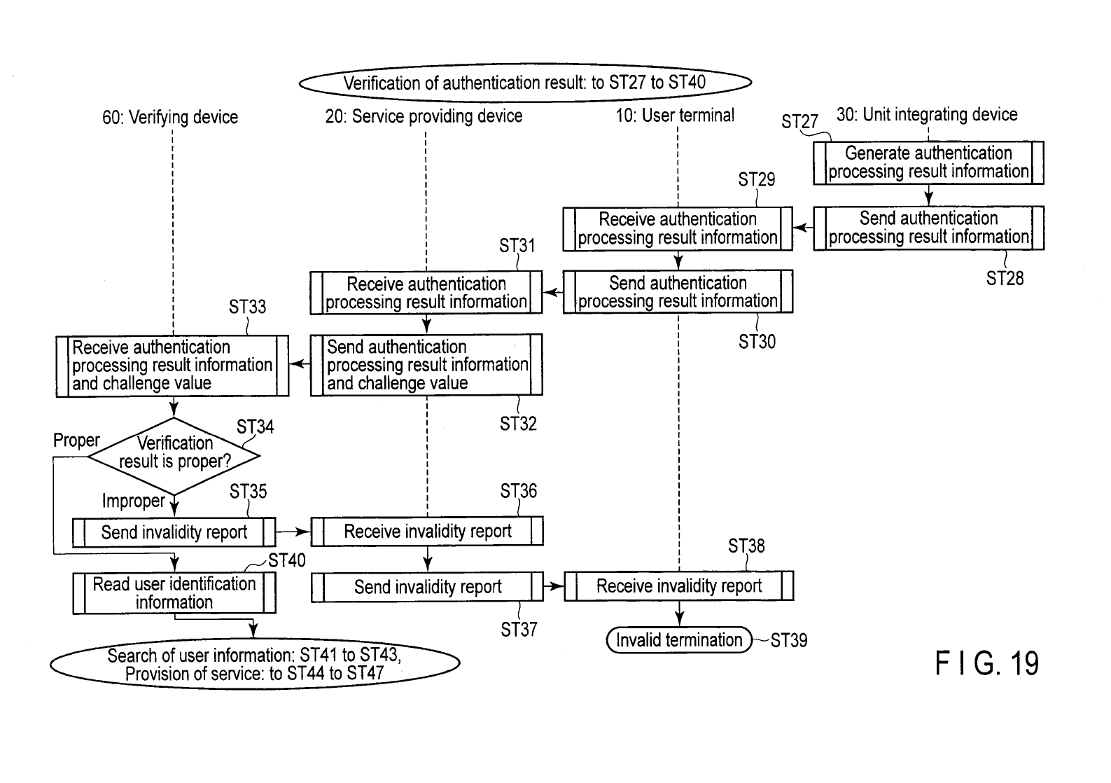

The unit integrating device 30 receives the second authentication constituting process result information b2 (ST26). As shown in FIG. 19, the control unit 32 ascertains that the processing of all the authentication constituting processes has been finished, and then sends the first authentication constituting process result information b1 and the second authentication constituting process result information b2 to the result information integrating unit 34. The result information integrating unit 34 generates authentication processing result information b (ST27). In the authentication processing result information b, the authentication contexts c1 and c2 in the authentication constituting process result information b1 and b2, and the execution result in the authentication constituting process result information b2 received from the last second unit device 50 in the processing order are described in a specific format.

The unit integrating device 30 sends the generated authentication processing result information b to the user terminal 10 (ST28).

When receiving the authentication processing result information b (ST29), the user terminal 10 sends the authentication processing result information b to the service providing device 20 as the result for the authentication request (ST30).

When receiving the authentication processing result information b (ST31), the service providing device 20 sends, to the verifying device 60, the challenge value previously held in step ST3, the authentication processing result information b, and the service providing policy 23b in the storage unit 23 (ST32).

When the verifying device 60 receives the challenge value, the authentication processing result information b, and the service providing policy 23b (ST33), the verifying unit 62 starts verification.

The verifying unit 62 verifies that the received authentication processing result information b fits the specific format. For example, the verifying unit 62 verifies that there is no missing information in the authentication processing result information b.

The verifying unit 62 verifies the authenticators in the authentication contexts c1 and c2 described in the received authentication processing result information b. The authenticators are verified by the corresponding public keys, for example, when the authenticators are digital signatures. The authenticators are verified by the common key previously shared by the unit devices 40 and 50 when the authenticators are message authentication codes.

The verifying unit 62 verifies the digital signatures in the equipment certificates 44a and 54a included in the authentication contexts c1 and c2 described in the received authentication processing result information b in accordance with the public key to the equipment certificate issuer in the storage unit 63.

The verifying unit 62 verifies the digital signature in the user identification information certificate 55b included in the authentication context c2 described in the received authentication processing result information b in accordance with the public key to the third-party organization in the storage unit 63.

The verifying unit 62 verifies the evaluation reports 44b and 54b included in the authentication contexts c1 and c2 described in the received authentication processing result information b in accordance with the received service providing policy 23b. Levels are assigned to the service providing classifications of the service providing policy 23b. The verification result by the verifying unit 62 is a service providing classification at the highest level that conforms to the service providing policy 23b. Here, the “level” means the level of a service. For example, conditions based on various perspectives correspond to the “level”: a money-based condition that permits use up to ten thousand yen or fifty thousand yen, or a time-based condition. This also applies to the explanations in the following embodiments.

The verifying unit 62 verifies the challenge values in the authentication contexts c1 and c2 described in the received authentication processing result information b in accordance with the received challenge value.

The verifying unit 62 verifies that the execution result described in the received authentication processing result information b is proper.

Subsequently, the verifying unit 62 judges whether all the verification results described above are proper (ST34). When even one of the verification results is not proper (ST34; improper), the verifying unit 62 judges this fact to be invalid, and reports the invalidity to the service providing device 20 (ST35). The service providing device 20 receives the invalidity report (ST36), and reports the invalidity to the user terminal 10 (ST37). The user terminal 10 receives the invalidity report (ST38), and finishes the processing (ST39).

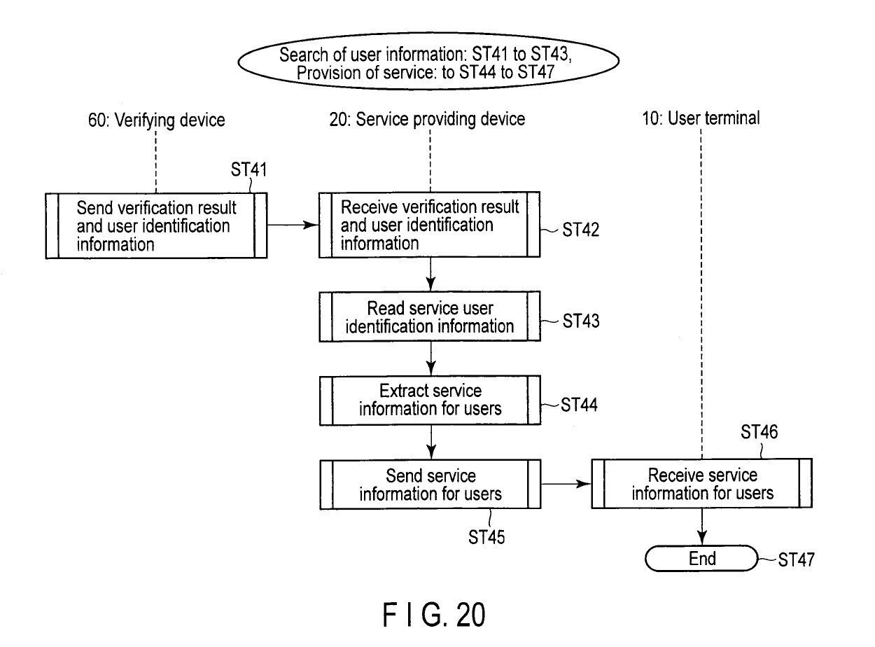

On the other hand, when all the verification results are proper (ST34; proper), the verifying device 60 reads the user identification information from the user identification information certificate 55b used for the verification (ST40). As shown in FIG. 20, the verifying device 60 then sends, to the service providing device 20, the user identification information, the verification result that indicates properness, and the service providing classification which is the verification result of the service providing policy 23b (ST41).

The service providing device 20 receives the user identification information and the verification result (ST42). When the verification result is proper, the service providing unit 22 then searches the storage unit 23 in accordance with the user identification information, and reads service user identification information (e.g., a credit card number) associated with the user identification information (ST43).

The service providing unit 22 extracts service information for users from the unshown storage unit in accordance with the read service user identification information (ST44), and sends the service information for users to the user terminal 10 (ST45). The service information provided for users is service information at a lower level selected from the level of the service providing classification of the user information 23a and the level of the service providing classification which is the verification result by the verifying device 60. The user identification information in the user identification information certificate 55b is provided by the TTP, and is different from the service user identification information provided by the operator of the service providing device 20.

The user terminal 10 receives the service information for users (ST46), and finishes the processing (ST47).

As described above, according to the present embodiment, verification is performed by the use of the authentication contexts c1 and c2, the equipment certificates 44a and 54a, the evaluation reports 44b and 54b, the user identification information certificate 55b, the service providing policy 23b, and the challenge value. This configuration eliminates the necessity of carrying and presenting a card such as a credit card or a bank card having service user identification information therein, and enables the identification of a user.

In the present embodiment, it is possible to verify that the authentication constituting process is reliable from the aspects [1] to [7] shown below.

[1] By the configuration that verifies the format of the authentication processing result information b, it is possible to check that there are no inadequacies in the authentication processing result information b serving for verification.

[2] By the configuration that verifies the authenticator, it is possible to check that the execution contents and execution results of the unit devices 40 and 50 are not altered.

[3] By the configuration that verifies the evaluation reports 44b and 54b, it is possible to check that the unit devices 40 and 50 are proper devices.

[4] By the configuration that verifies the user identification information certificate 55b, it is possible to check that user identification information is proper user identification information for the user which has undergone biometric authentication.

[5] By the configuration that verifies the evaluation reports 44b and 54b, it is possible to check that the unit devices 40 and 50 satisfy the service providing policy.

[6] By the configuration that verifies the challenge value, it is possible to check that there is no replay attack of the authentication processing result information b. It is assumed that the replay attack here is an attack in which a malicious third party holds the authentication processing result information b for the user collected from a network and then resends the authentication processing result information b to pretend to be this user. The challenge value is a random value generated for every authentication processing, so that even in the case of such a replay attack, the replay attack can be detected if the challenge value does not correspond.

[7] By the execution result verifying function, it is possible to check that the execution result of the biometric authentication is proper.

In the present embodiment, the user identification information in the user identification information certificate 55b is different from service user identification information such as a credit card number. Therefore, the service user identification information is not transmitted on the network, so that the possibility of the leakage of the service user identification information can be reduced. In addition, the user can use a service even if the user does not know the service user identification information. Thus, when the credit card is discontinued, inadvertent leakage of the service user identification information attributed to the user can be prevented.

The service providing system described in the present embodiment can be applied to various models of biometric authentications.

For example, in the case of an on-card matching (OCM) model of the biometric authentication, the first unit device 40 performs the collection and signal processing of biometric data. The second unit device 50 holds a template which is previously registered biometric referential information, checks the signal processing result from the first unit device 40 against the template, and outputs a judgment result based on the matching result.

In the case of a store on card (STOC) model of the biometric authentication, the first unit device 40 performs the collection and signal processing of biometric data. The unit device 50 holds a template which is previously registered biometric referential information, and supplies the template to the first unit device 40 or a third unit device. The third unit device is not described in the present embodiment, and is described here for the first time. The first unit device 40 or the third unit device checks the signal processing result from the first unit device 40 against the template, and outputs a judgment result based on the matching result. The third unit device is substantially similar in configuration and operation to the first unit device 40.

### Second Embodiment

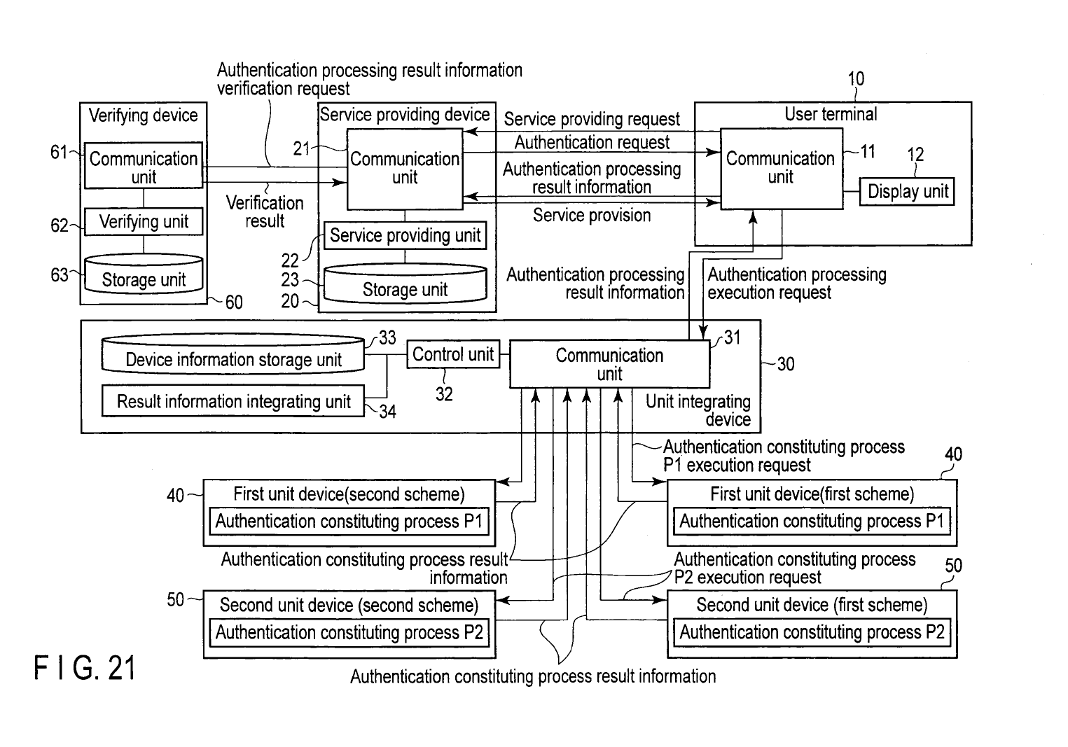

FIG. 21 is a schematic diagram showing the configuration of a service providing system according to a second embodiment. Parts similar to those in FIG. 1 are indicated by the same reference signs and not described in detail. Here, differences are mainly described. Repeated explanations are not given in the following embodiments either.

The present embodiment is a modification of the present embodiment, and uses multimodal biometric authentication. The multimodal biometric authentication is biometric authentication that makes a judgment by mixing two or more matching results based on biometric information and thus permits more accurate biometric authentication.

The configuration of the unit device varies depending on which of the OCM and STOC models described in the end of the first embodiment is used for each piece of the biometric information. Meanwhile, the unit device that includes an actually used template functions in the same manner as the second unit device 50 according to the first embodiment. The unit device that includes no template and that performs the authentication constituting process operates in the same manner as the first unit device 40 according to the first embodiment.

Here, the OCM model is used. As shown, first and second unit devices 40 and 50 of a first scheme, and first and second unit devices 40 and 50 of a second scheme are provided. The first and second unit devices 40 and 50 of the first scheme and the first and second unit devices 40 and 50 of the second scheme are only different from each other in biometric authentication method (e.g., a fingerprint authentication method and a face authentication method), and have the same function blocks.

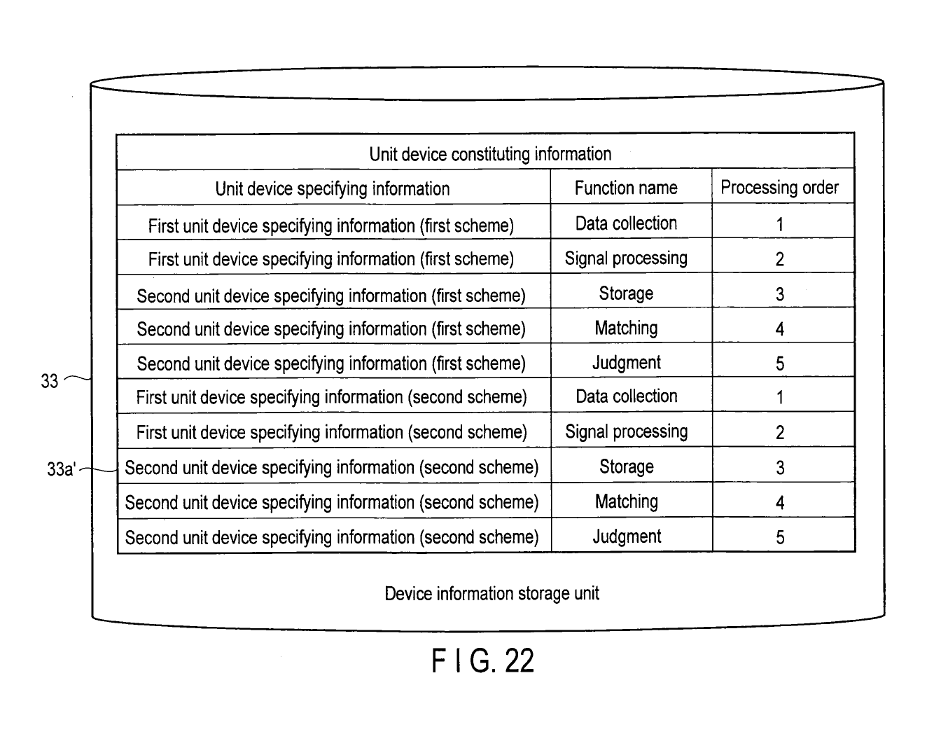

As shown in FIG. 22, in a unit integrating device 30, a unit device constituting information 33a′ in a device information storage unit 33 is described in conformity to the first and second unit devices 40 and 50 of each scheme.

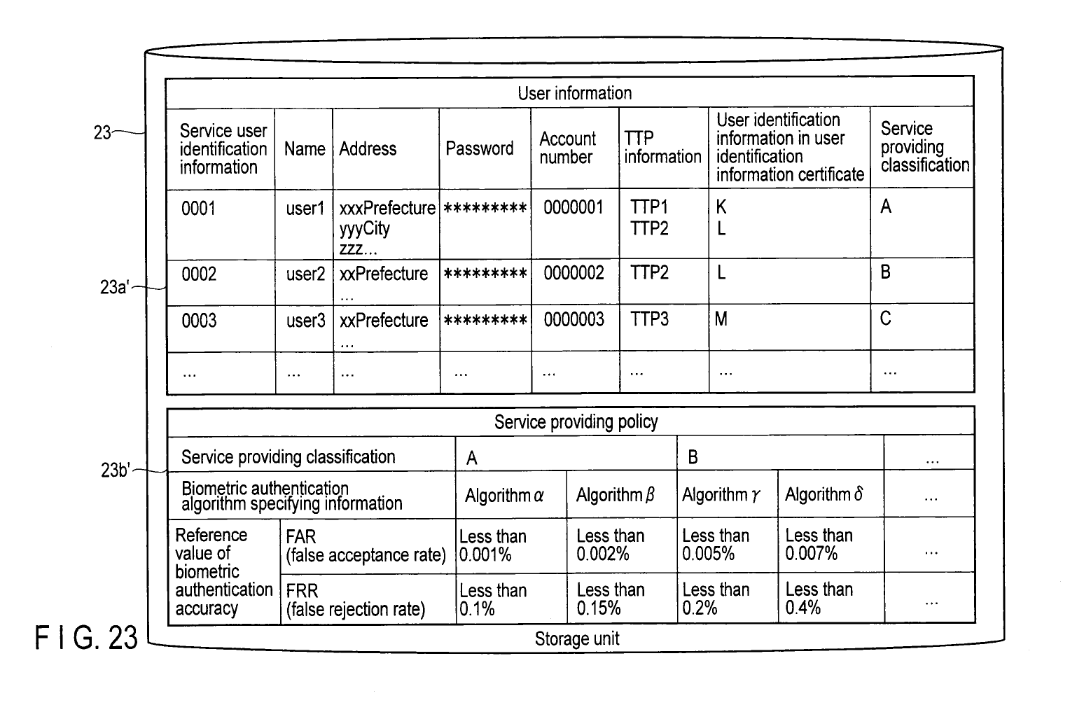

As shown in FIG. 23, in a service providing device 20, user identification information in a user identification information certificate and TTP information in user information 23a′ within a storage unit 23 are described for the first scheme and the second scheme.

Regarding a service providing policy 23b′ within the storage unit 23, biometric authentication constituting process information and a reference value of biometric authentication accuracy are described for the first scheme and the second scheme in one service A.

For example, biometric authentication constituting process information α and γ are provided for the first scheme, and biometric authentication constituting process information β and δ are provided for the second scheme. In this case, regarding the service A and a service B, it is possible to select and use the biometric authentication constituting process information α and γ for the first scheme, and the biometric authentication constituting process information β and δ for the second scheme. This is not limited to the service A and the service B, and is applied to target services.

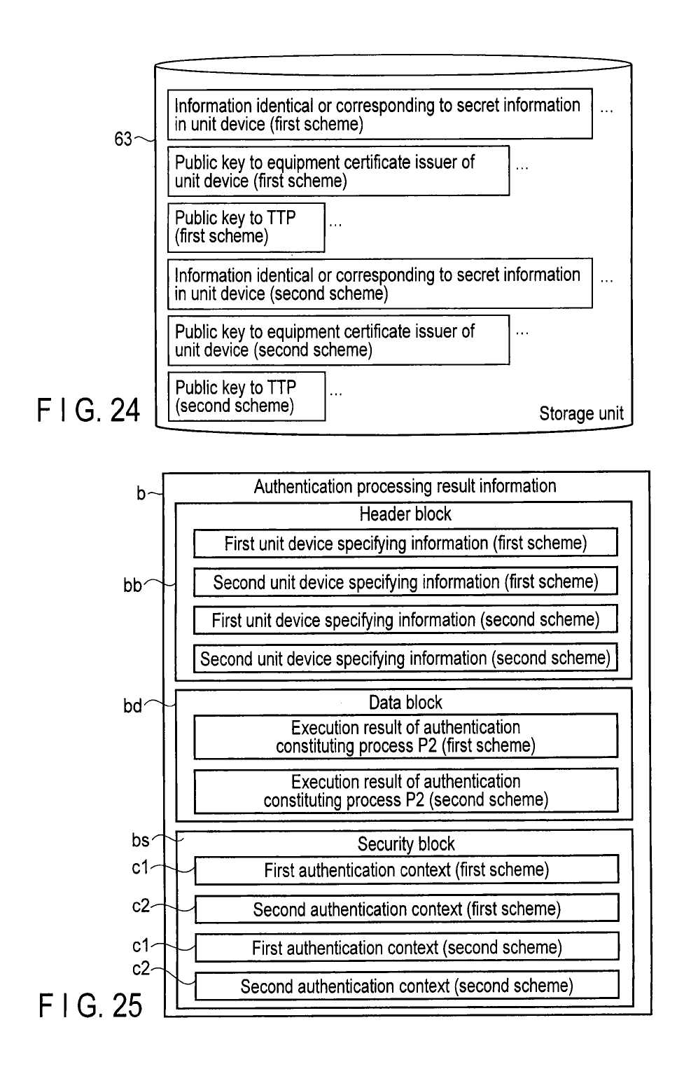

As shown in FIG. 24, in a verifying device 60, information and public keys identical or corresponding to secret information for the unit devices 40 and 50 of the storage unit 63 are described for the first scheme and the second scheme.

As shown in FIG. 25, in authentication processing result information b output by the unit integrating device 30, first and second unit device specifying information, the execution result of the authentication constituting process P2, and first and second authentication contexts c1 and c2 are described in conformity to the first scheme and the second scheme.

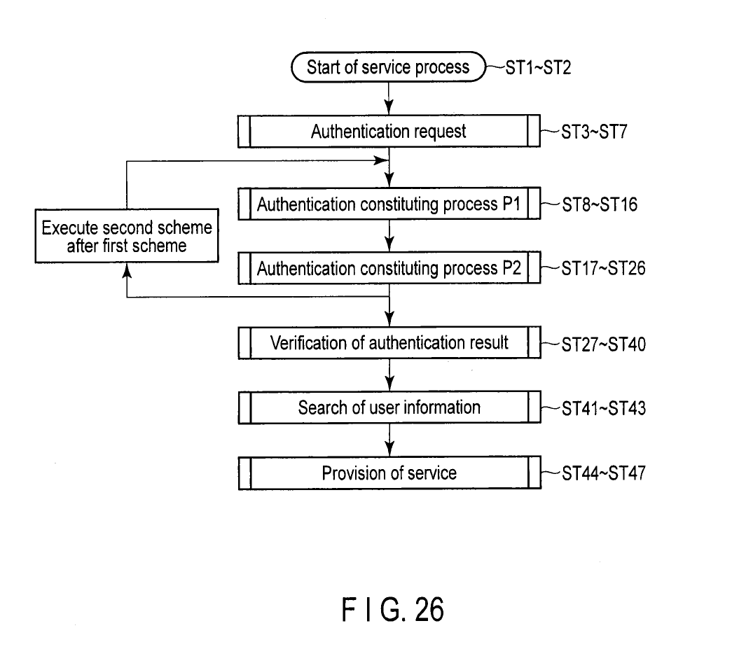

Now, the operation of the service providing system having the above configuration is described with reference to the flowchart in FIG. 26.

Processes in steps ST1 to ST7 are performed in the manner described above.

Processes in steps ST8 to ST26 are performed so that the second scheme is performed after the first scheme.

Processes in steps ST27 to ST39 are performed in the manner described above.

In a process in step ST40, the verifying device 60 reads all the different user identification information.

Processes in steps ST41 to ST42 are performed in the manner described above.

In a process in step ST43, the service providing device 20 searches pieces of user identification information.

Processes in steps ST44 to ST47 are performed in the manner described above.

As described above, according to the present embodiment, the first and second unit devices 40 and 50 of the first scheme and the first and second unit devices 40 and 50 of the second scheme are provided. This configuration allows the application of the first embodiment to the multimodal biometric authentication.

### Third Embodiment

Now, a service providing system according to a third embodiment is described.

The present embodiment is a modification of the present embodiment. In order to reduce the effect of the modification of a user identification information certificate 55b on a service providing device 20, the service providing device 20 does not hold the user identification information in the user identification information certificate 55b.

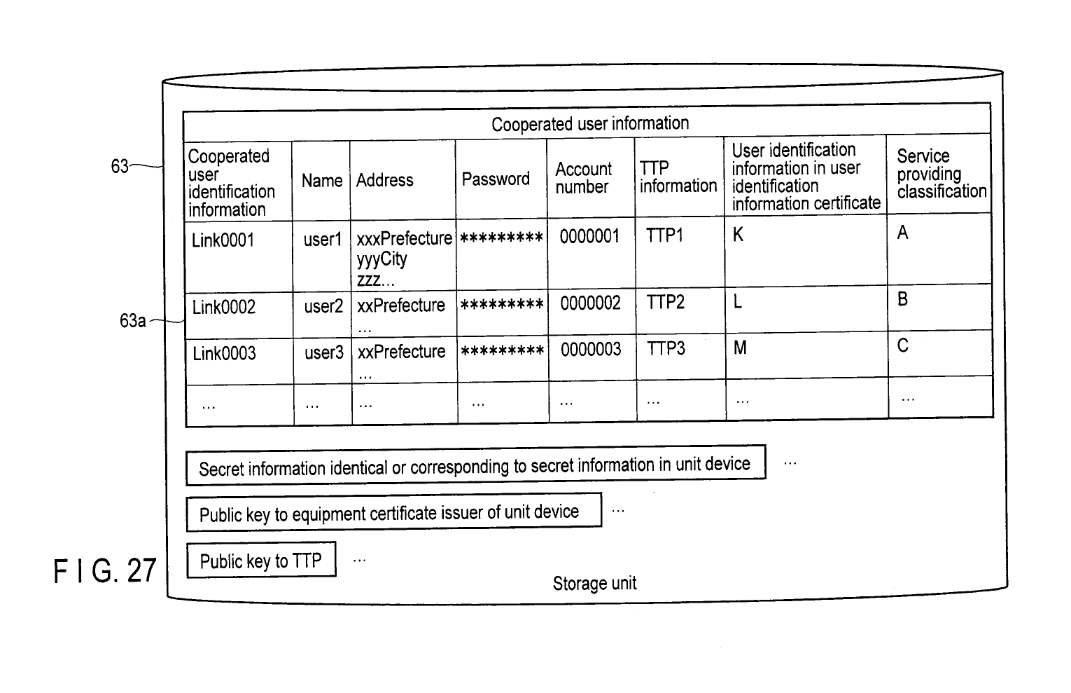

More specifically, as shown in FIG. 27, cooperated user information 63a is stored in a storage unit 63 of a verifying device 60 in addition to the aforementioned information and public keys identical or corresponding to secret information for unit devices 40 and 50. In the cooperated user information 63a, the user identification information in the user identification information certificate 55b, and cooperated user identification information which has a value different from that of the user identification information to identify the user are described in association with each other. A user name, an address, a password, an account number, TTP information, and a service ID may be further described in the cooperated user information 63a in association with one another.

The verifying unit 62 has a next cooperated user identification information sending function (f62-9)′ instead of the aforementioned user identification information sending function (f62-9):

(f62-9)′ A cooperated user identification information sending function to send, to the service providing device 20, the cooperated user identification information read from the cooperated user information 63a in accordance with the user identification information in the user identification information certificate 55b used for the verification by the user identification information certificate verifying function and the verification result that indicates properness when all the verification results by the format verifying function, the authenticator verifying function, the equipment certificate verifying function, the user identification information certificate verifying function, the evaluation report verifying function, the challenge value verifying function, and the execution result verifying function are proper.

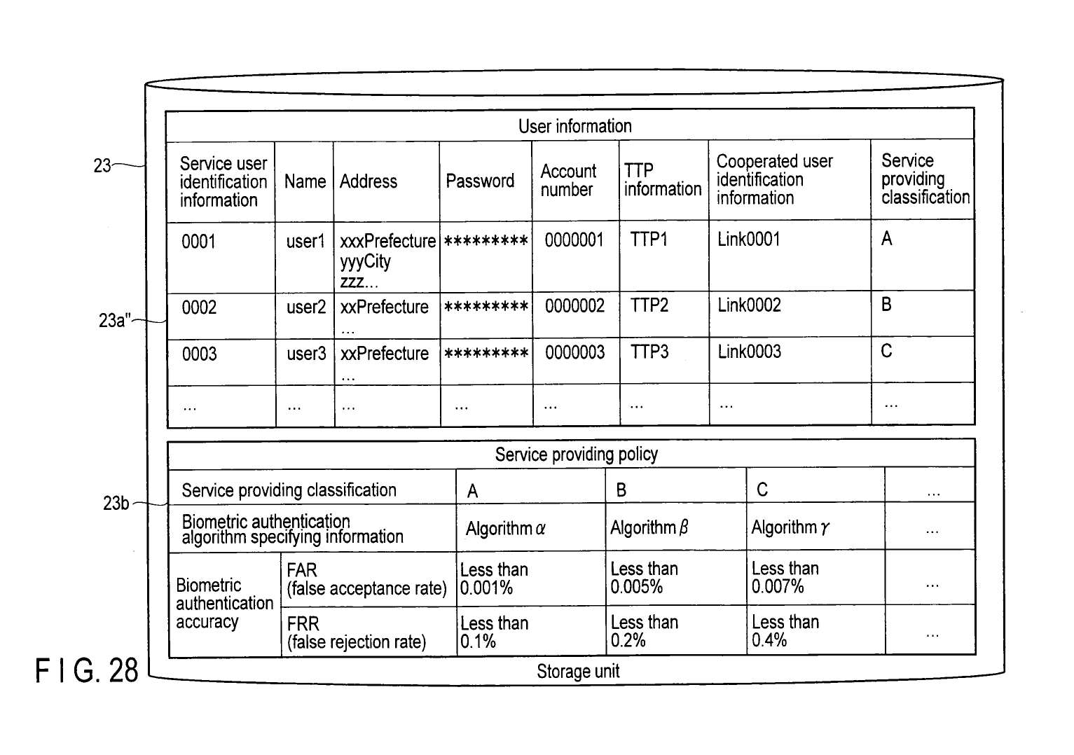

On the other hand, as shown in FIG. 28, user information 23a″ in which cooperated user identification information is described is stored in the storage unit 23 of the service providing device 20 instead of the aforementioned “user identification information in the user identification information certificate 55b” in the user information 23a. The cooperated user identification information in the user information 23a″ is the same as the cooperated user identification information in the storage unit 63 of the verifying device 60. The service user identification information in the user information 23a″ has a value different from those of the cooperated user identification information and the “user identification information in the user identification information certificate 55b” to identify the user, and is associated with the cooperated user identification information.

The service providing unit 22 has a next cooperated read function (f22-3)′ instead of the aforementioned read function (f22-3):

(f22-3)′ A cooperated read function to search the storage unit 23 in accordance with the cooperated user identification information and read service user identification information associated with the cooperated user identification information in response to the cooperated user identification information and the verification result from the verifying device 60 when the verification result is proper.

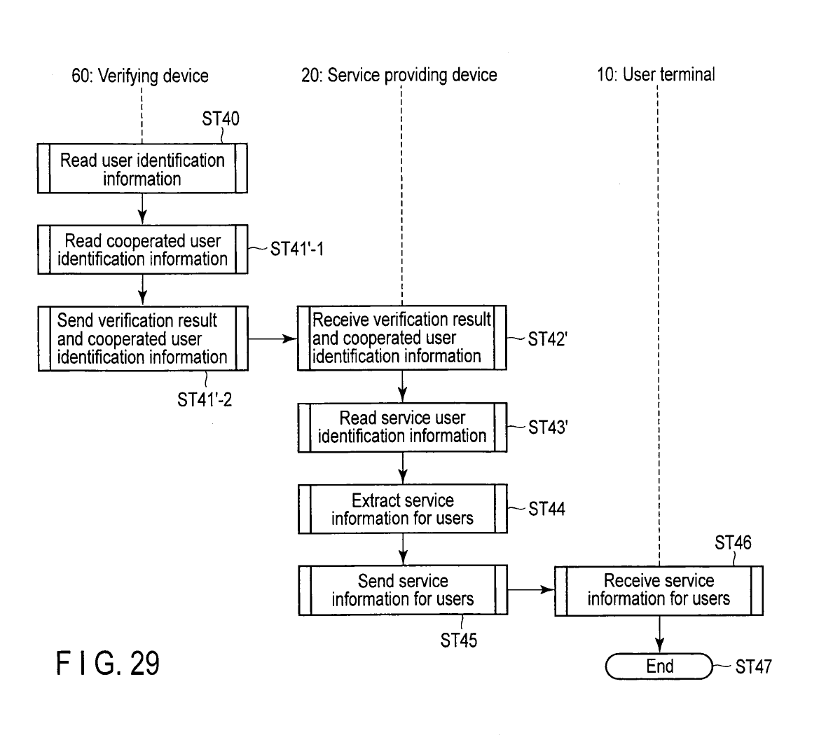

Now, the operation of the service providing system having the above configuration is described with reference to flowchart in FIG. 29.

Processes in steps ST1 to ST40 are performed in the manner described above.

The verifying unit 62 of the verifying device 60 reads the cooperated user identification information from the storage unit 63 in accordance with the user identification information read in step ST40 (ST41′-1), and sends, to the service providing device 20, the read cooperated user identification information and the verification result that indicates properness (step ST41′-2).

In response to cooperated user identification information and the verification result (step ST42′), the service providing device 20 searches the storage unit 23 in accordance with the cooperated user identification information when the verification result is proper, reads service user identification information (e.g., a credit card number) associated with the cooperated user identification information (step ST43′), extracts service information for users from the service providing unit 22 (step ST44), and sends the service information for users to the user terminal 10 (step ST45). The cooperated user identification information is provided by the operator of the verifying device 60, and is different from the service user identification information provided by the operator of the service providing device 20.

The user terminal 10 receives the service information for users (ST46), and finishes the processing (ST47).

As described above, according to the present embodiment, the service providing device 20 does not hold the user identification information in the user identification information certificate 55b. This configuration can reduce the effect of the modification of the user identification information on the service providing device 20, in addition to the advantageous effects similar to those according to the first embodiment.

The present embodiment is a modification of the verifying device 60 and the service providing device 20, and can therefore be applied not only as the modification of the first embodiment but also as the modification of the second embodiment.

According to at least one of the embodiments described above, the authentication contexts c1 and c2 have the equipment certificates 44a and 54a, the evaluation reports 44b and 54b, the challenge value from the service providing device 20, and the hash value and the authenticator of the execution result of the authentication constituting process. The second authentication context c2 further has the user identification information certificate. The authentication processing result information b has the execution result of the authentication constituting process P2 and the authentication contexts c1 and c2. According to this configuration, the verifying device 60 can perform verification by the verification functions. This eliminates the necessity of carrying and presenting a card having service user identification information therein, and enables the identification of a user.

As none of the devices 10 to 60 send and receive the service user identification information, the possibility of the leakage of the service user identification information can be reduced.

The method described in the embodiment can also be stored in a storage medium such as a magnetic disk (Floppy™ disk, hard disk, or the like), an optical disk (CD-ROM, DVD, or the like), a magneto-optical disk (MO), or a semiconductor memory as a program which can be executed by a computer and distributed.

As the storage medium, any configuration which is a computer-readable storage medium in which a program can be stored may be used regardless of a storage format.

An OS (operating system) which operates on a computer on the basis of an instruction of a program installed from the storage medium in the computer, database management software, and MW (middleware) such as network software may execute a part of the processes to realize the embodiment.

Furthermore, the storage medium according to the present invention includes not only a medium independent of a computer but also a storage medium in which a program transmitted through a LAN, the Internet, or the like is downloaded and stored or temporarily stored.

The number of storage media is not limited to one. A case in which the process in the embodiment is executed from a plurality of media is included in the storage medium according to the present invention. Any medium configuration may be used.

A computer according to the present invention is to execute the processes in the embodiments on the basis of the program stored in a storage medium. The computer may have any configuration such as one apparatus constituted by a personal computer or a system in which a plurality of apparatuses are connected by a network.

A computer in each embodiment includes not only a personal computer but also an arithmetic processing apparatus, a microcomputer, or the like included in an information processing apparatus. The computer is a generic name of an apparatus and a device which can realize the functions of the present invention by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A service providing system comprising: a plurality of unit devices which independently execute authentication constituting processes constituting authentication processing that uses biometric authentication; a unit integrating device which has each of the unit devices provided therein or externally connected thereto to communicate with each of the unit devices; a user terminal which has the unit integrating device provided therein or externally connected thereto to communicate with the unit integrating device; a verifying device which verifies the execution contents of each of the authentication constituting processes in accordance with an authenticator; and a service providing device which communicates with the user terminal and the verifying device,
each of the unit devices comprising
an equipment certificate storage module which stores an equipment certificate issued to each of the unit devices by an equipment certificate issuer in accordance with a public key encryption method, the equipment certificate including an equipment certificate body and a digital signature generated for the equipment certificate body by a secret key to the equipment certificate issuer, the equipment certificate body including identification information for a public key of or for secret information to generate a message authentication code of the unit device to which the authentication constituting process belongs, unit device specifying information to specify the unit device to which the authentication constituting process belongs, and equipment certificate issuer information to specify the equipment certificate issuer,
an evaluation report storage module which stores an evaluation report, the evaluation report including the unit device specifying information of the unit device used for the execution of the authentication constituting process, biometric authentication constituting process information to specify a biometric authentication constituting process including a biometric authentication algorithm, and biometric authentication accuracy indicating the accuracy of the biometric authentication by the biometric authentication algorithm,
a secret information storage module which stores secret information to generate the authenticator,
an authentication constituting process executing module which executes the authentication constituting process when each of the unit devices receives, from the unit integrating device, an authentication constituting process execution request to request the execution of the authentication constituting process,
an authenticator generating module which generates the authenticator by the use of the secret information in accordance with the equipment certificate, the evaluation report, the challenge value, and a hash value of the execution contents,
an authentication context generating module which generates an authentication context, the equipment certificate, the evaluation report, the challenge value, the hash value of the execution contents, and the authenticator being described in the authentication context in a specific format,
an authentication constituting process result information generating module which generates authentication constituting process result information in which the authentication context and the execution result of the authentication constituting process are described in a specific format, and
a result information sending module which sends the authentication constituting process result information to the unit integrating device,
at least one of the unit devices further comprising
a user identification information certificate storage module which stores a user identification information certificate issued to a user of the user terminal by a third-party organization in accordance with a public key encryption method, the user identification information certificate including a certificate body and a digital signature generated for the certificate body by a secret key to the third-party organization, the certificate body including user identification information to identify the user, a hash value of biometric referential information for the user, and the third-party organization information to identify the third-party organization,
the authenticator generating module of at least one of the unit devices generating the authenticator by the use of the secret information in accordance with the equipment certificate, the evaluation report, the challenge value, the user identification information certificate, and the hash value of the execution contents,
the authentication context generating module of at least one of the unit devices generating an authentication context, the equipment certificate, the evaluation report, the challenge value, the user identification information certificate, the hash value of the execution contents, and the authenticator being described in the authentication context in a specific format,
the unit integrating device comprising
a device information storage module which stores, in association with one another, unit device specifying information for each of the unit devices, a function name indicating a function in an authentication constituting process executed by each of the unit devices, and a processing order indicating the order of processing the functions,
a first authentication constituting process execution request sending module which sends the challenge value and the authentication constituting process execution request to the unit device specified by the unit device specifying information in accordance with the processing order and the unit device specifying information in the device information storage module in response to an authentication processing execution request to request the execution of the authentication processing and the challenge value from the user terminal,
a second authentication constituting process execution request sending module which sends the challenge value and the authentication constituting process execution request to the unit device subsequent to the sending destination unit device in the processing order in accordance with the processing order and the unit device specifying information in the device information storage module in response to the authentication constituting process result information from the unit device which is a sending destination of the authentication constituting process execution request,
an authentication processing result information generating module which generates authentication processing result information in accordance with the processing order and the unit device specifying information in the unit device constituting information in response to the authentication constituting process result information from the unit device which is a sending destination of the authentication constituting process execution request when the sending destination unit device is the last unit device in the processing order, the authentication context in the authentication constituting process result information received from each of the unit devices and the execution result in the authentication constituting process result information received from the last unit device in the processing order being described in the authentication processing result information in a specific format, and
an authentication processing result information sending module which sends the authentication processing result information to the user terminal,
the user terminal comprising
a service request sending module which sends, to the service providing device, a service request to request a service to the service providing device,
an authentication processing execution request sending module which sends, to the unit integrating device, the challenge value and the authentication processing execution request in response to an authentication request which requests the user to perform the biometric authentication, and the challenge value from the service providing device,
a transfer module which transfers, to the service providing device, authentication processing result information received from the unit integrating device, and
a display module which displays service information received from the service providing device,
the service providing device comprising
a user information storage module which stores, in association with each other, user identification information in the user identification information certificate, and service user identification information which has a value different from that of the user identification information to identify the user,
a service providing policy storage module which stores a service providing policy indicating conditions for providing services to the user, the service providing policy including service identification information to identify the service, unit device specifying information used for the execution of the authentication constituting processes, biometric authentication constituting process information to specify a biometric authentication constituting process including a biometric authentication algorithm, and a reference value indicating a reference for regarding the accuracy of the biometric authentication by the biometric authentication algorithm as proper,
an authentication request sending module which generates and holds the challenge value and sends the challenge value and the authentication request to the user terminal in response to a service request from the user terminal,
a sending module which sends the held challenge value, the authentication processing result information, and the service providing policy to the verifying device in response to authentication processing result information from the user terminal,
a read module which searches the user information storage module in accordance with the user identification information and reads service user identification information associated with the user identification information in response to user identification information and a verification result from the verifying device when the verification result is proper, and
a service information sending module which sends the service information to the user terminal in accordance with the read service user identification information,
the verifying device comprising
a public key storage module which stores a public key to the equipment certificate issuer of each of the unit devices and a public key to the third-party organization,
a receiving module which receives, from the service providing device, the challenge value, the authentication processing result information, and the service providing policy,
a format verifying module which verifies that the received authentication processing result information fits the specific format,
an authenticator verifying module which verifies an authenticator in the authentication context described in the received authentication processing result information,
an equipment certificate verifying module which verifies the digital signature in the equipment certificate included in the authentication context described in the received authentication processing result information in accordance with the public key to the equipment certificate issuer,
a user identification information certificate verifying module which verifies the digital signature in the user identification information certificate included in the authentication context described in the received authentication processing result information in accordance with the public key to the third-party organization,
an evaluation report verifying module which verifies the evaluation report included in the authentication context described in the received authentication processing result information in accordance with the received service providing policy,
a challenge value verifying module which verifies the challenge value in the authentication context described in the received authentication processing result information in accordance with the received challenge value,
an execution result verifying module which verifies that the execution result described in the received authentication processing result information is proper, and
a user identification information sending module which sends, to the service providing device, the user identification information in the user identification information certificate used for the verification by the user identification information certificate verifying module and the verification result that indicates properness when all the verification results by the format verifying module, the authenticator verifying module, the equipment certificate verifying module, the user identification information certificate verifying module, the evaluation report verifying module, the challenge value verifying module, and the execution result verifying module are proper.

2. The service providing system according to claim 1, wherein
the authenticator verifying module verifies the authenticator generated by each of the unit devices in accordance with information identical or corresponding to the secret information in each of the unit devices.

3. The service providing system according to claim 1, wherein
the secret information in the secret information storage module is a secret key in a public key encryption method, and
the authenticator generated by the authenticator generating module is a digital signature generated on the basis of the secret key.

4. A service providing system comprising: a plurality of unit devices which independently execute authentication constituting processes constituting authentication processing that uses biometric authentication; a unit integrating device which has each of the unit devices provided therein or externally connected thereto to communicate with each of the unit devices; a user terminal which has the unit integrating device provided therein or externally connected thereto to communicate with the unit integrating device; a verifying device which verifies the execution contents of each of the authentication constituting processes in accordance with an authenticator; and a service providing device which communicates with the user terminal and the verifying device,
each of the unit devices comprising
an equipment certificate storage module which stores an equipment certificate issued to each of the unit devices by an equipment certificate issuer in accordance with a public key encryption method, the equipment certificate including an equipment certificate body and a digital signature generated for the equipment certificate body by a secret key to the equipment certificate issuer, the equipment certificate body including identification information for a public key of or for secret information to generate a message authentication code of the unit device to which the authentication constituting process belongs, unit device specifying information to specify the unit device to which the authentication constituting process belongs, and equipment certificate issuer information to specify the equipment certificate issuer,
an evaluation report storage module which stores an evaluation report, the evaluation report including the unit device specifying information of the unit device used for the execution of the authentication constituting process, biometric authentication constituting process information to specify a biometric authentication constituting process including a biometric authentication algorithm, and biometric authentication accuracy indicating the accuracy of the biometric authentication by the biometric authentication algorithm,
a secret information storage module which stores secret information to generate the authenticator,
an authentication constituting process executing module which executes the authentication constituting process when each of the unit devices receives, from the unit integrating device, an authentication constituting process execution request to request the execution of the authentication constituting process,
an authenticator generating module which generates the authenticator by the use of the secret information in accordance with the equipment certificate, the evaluation report, the challenge value, and a hash value of the execution contents,
an authentication context generating module which generates an authentication context, the equipment certificate, the evaluation report, the challenge value, the hash value of the execution contents, and the authenticator being described in the authentication context in a specific format,
an authentication constituting process result information generating module which generates authentication constituting process result information in which the authentication context and the execution result of the authentication constituting process are described in a specific format, and
a result information sending module which sends the authentication constituting process result information to the unit integrating device,
at least one of the unit devices further comprising
a user identification information certificate storage module which stores a user identification information certificate issued to a user of the user terminal by a third-party organization in accordance with a public key encryption method, the user identification information certificate including a certificate body and a digital signature generated for the certificate body by a secret key to the third-party organization, the certificate body including user identification information to identify the user, a hash value of biometric referential information for the user, and the third-party organization information to identify the third-party organization,
the authenticator generating module of at least one of the unit devices generating the authenticator by the use of the secret information in accordance with the equipment certificate, the evaluation report, the challenge value, the user identification information certificate, and the hash value of the execution contents,
the authentication context generating module of at least one of the unit devices generating an authentication context, the equipment certificate, the evaluation report, the challenge value, the user identification information certificate, the hash value of the execution contents, and the authenticator being described in the authentication context in a specific format,
the unit integrating device comprising
a device information storage module which stores, in association with one another, unit device specifying information for each of the unit devices, a function name indicating a function in an authentication constituting process executed by each of the unit devices, and a processing order indicating the order of processing the functions,
a first authentication constituting process execution request sending module which sends the challenge value and the authentication constituting process execution request to the unit device specified by the unit device specifying information in accordance with the processing order and the unit device specifying information in the device information storage module in response to an authentication processing execution request to request the execution of the authentication processing and the challenge value from the user terminal,
a second authentication constituting process execution request sending module which sends the challenge value and the authentication constituting process execution request to the unit device subsequent to the sending destination unit device in the processing order in accordance with the processing order and the unit device specifying information in the device information storage module in response to the authentication constituting process result information from the unit device which is a sending destination of the authentication constituting process execution request,
an authentication processing result information generating module which generates authentication processing result information in accordance with the processing order and the unit device specifying information in the unit device constituting information in response to the authentication constituting process result information from the unit device which is a sending destination of the authentication constituting process execution request when the sending destination unit device is the last unit device in the processing order, the authentication context in the authentication constituting process result information received from each of the unit devices and the execution result in the authentication constituting process result information received from the last unit device in the processing order being described in the authentication processing result information in a specific format, and
an authentication processing result information sending module which sends the authentication processing result information to the user terminal,
the user terminal comprising
a service request sending module which sends, to the service providing device, a service request to request a service to the service providing device,
an authentication processing execution request sending module which sends, to the unit integrating device, the challenge value and the authentication processing execution request in response to an authentication request which requests the user to perform the biometric authentication, and the challenge value from the service providing device,
a transfer module which transfers, to the service providing device, authentication processing result information received from the unit integrating device, and
a display module which displays service information received from the service providing device,
the service providing device comprising
a service user identification information storage module which stores, in association with each other, cooperated user identification information which has a value different from that of the user identification information to identify the user, and service user identification information which has a value different from those of the cooperated user identification information and the user identification information to identify the user,
a service providing policy storage module which stores a service providing policy indicating conditions for providing services to the user, the service providing policy including service identification information to identify the service, unit device specifying information used for the execution of the authentication constituting processes, biometric authentication constituting process information to specify a biometric authentication constituting process including a biometric authentication algorithm, and a reference value indicating a reference for regarding the accuracy of the biometric authentication by the biometric authentication algorithm as proper,
an authentication request sending module which generates and holds the challenge value and sends the challenge value and the authentication request to the user terminal in response to a service request from the user terminal,
a sending module which sends the held challenge value, the authentication processing result information, and the service providing policy to the verifying device in response to authentication processing result information from the user terminal,
a cooperated read module which searches the service user identification information storage module in accordance with the cooperated user identification information and reads service user identification information associated with the cooperated user identification information in response to the cooperated user identification information and the verification result from the verifying device when the verification result is proper, and
a service information sending module which sends the service information to the user terminal in accordance with the read service user identification information,
the verifying device comprising
a public key storage module which stores a public key to the equipment certificate issuer of each of the unit devices and a public key to the third-party organization,
a receiving module which receives, from the service providing device, the challenge value, the authentication processing result information, and the service providing policy,
a format verifying module which verifies that the received authentication processing result information fits the specific format,
an authenticator verifying module which verifies an authenticator in the authentication context described in the received authentication processing result information,
an equipment certificate verifying module which verifies the digital signature in the equipment certificate included in the authentication context described in the received authentication processing result information in accordance with the public key to the equipment certificate issuer,
a user identification information certificate verifying module which verifies the digital signature in the user identification information certificate included in the authentication context described in the received authentication processing result information in accordance with the public key to the third-party organization,
an evaluation report verifying module which verifies the evaluation report included in the authentication context described in the received authentication processing result information in accordance with the received service providing policy,
a challenge value verifying module which verifies the challenge value in the authentication context described in the received authentication processing result information in accordance with the received challenge value,
an execution result verifying module which verifies that the execution result described in the received authentication processing result information is proper,
a cooperated user information storage module which stores, in association with each other, the user identification information in the user identification information certificate, and cooperated user identification information which is the same as the former cooperated user identification information having a value different from that of the user identification information to identify the user, and
a cooperated user identification information sending module which sends, to the service providing device, the cooperated user identification information read from the cooperated user information storage module and the verification result that indicates properness in accordance with the user identification information in the user identification information certificate used for the verification by the user identification information certificate verifying module when all the verification results by the format verifying module, the authenticator verifying module, the equipment certificate verifying module, the user identification information certificate verifying module, the evaluation report verifying module, the challenge value verifying module, and the execution result verifying module are proper.

5. The service providing system according to claim 4, wherein
the authenticator verifying module verifies the authenticator generated by each of the unit devices in accordance with information identical or corresponding to the secret information in each of the unit devices.

6. The service providing system according to claim 4, wherein
the secret information in the secret information storage module is a secret key in a public key encryption method, and
the authenticator generated by the authenticator generating module is a digital signature generated on the basis of the secret key.

7. At least one of a plurality of unit devices used in a service providing system, the service providing system comprising the unit devices which independently execute authentication constituting processes constituting authentication processing that uses biometric authentication, a unit integrating device which has each of the unit devices provided therein or externally connected thereto to communicate with each of the unit devices, a user terminal which has the unit integrating device provided therein or externally connected thereto to communicate with the unit integrating device, a verifying device which verifies the execution contents of each of the authentication constituting processes in accordance with an authenticator, and a service providing device which communicates with the user terminal and the verifying device, the unit device comprising:
an equipment certificate storage module which stores an equipment certificate issued to each of the unit devices by an equipment certificate issuer in accordance with a public key encryption method, the equipment certificate including an equipment certificate body and a digital signature generated for the equipment certificate body by a secret key to the equipment certificate issuer, the equipment certificate body including identification information for a public key of or for secret information to generate a message authentication code of the unit device to which the authentication constituting process belongs, unit device specifying information to specify the unit device to which the authentication constituting process belongs, and equipment certificate issuer information to specify the equipment certificate issuer;
an evaluation report storage module which stores an evaluation report, the evaluation report including the unit device specifying information of the unit device used for the execution of the authentication constituting process, biometric authentication constituting process information to specify a biometric authentication constituting process including a biometric authentication algorithm, and biometric authentication accuracy indicating the accuracy of the biometric authentication by the biometric authentication algorithm;
a user identification information certificate storage module which stores a user identification information certificate issued to a user of the user terminal by a third-party organization in accordance with a public key encryption method, the user identification information certificate including a certificate body and a digital signature generated for the certificate body by a secret key to the third-party organization, the certificate body including user identification information to identify the user, a hash value of biometric referential information for the user, and the third-party organization information to identify the third-party organization;
a secret information storage module which stores secret information to generate the authenticator;
an authentication constituting process executing module which executes the authentication constituting process when receiving, from the unit integrating device, an authentication constituting process execution request to request the execution of the authentication constituting process;
an authenticator generating module which generates the authenticator by the use of the secret information in accordance with the equipment certificate, the evaluation report, the challenge value, the user identification information certificate, and a hash value of the execution contents;
an authentication context generating module which generates an authentication context, the equipment certificate, the evaluation report, the challenge value, the user identification information certificate, the hash value of the execution contents, and the authenticator being described in the authentication context in a specific format;
an authentication constituting process result information generating module which generates authentication constituting process result information in which the authentication context and the execution result of the authentication constituting process are described in a specific format; and
a result information sending module which sends the authentication constituting process result information to the unit integrating device,
wherein the authentication context and the execution result are extracted as the authentication constituting process result information by the unit integrating device,
the extracted authentication context and execution result are described in authentication processing result information in a specific format by the unit integrating device, and
the authentication processing result information is sent to the service providing device from the unit integrating device via the user terminal, the authentication context and the execution result are extracted by the verifying device after the authentication processing result information to which the challenge value and a service providing policy are added by the service providing device is sent, and the verifying device verifies the execution result, the format of the authentication processing result information, the authenticator in the authentication context, the equipment certificate, the evaluation report, the user identification information certificate, and the challenge value.
